(19) United States
(12) Patent Application Publication
(10) Pub. No.: US 2026/0259465 A1
(43) Pub. Date: Sep. 3, 2026

(54) ELECTROCHROMIC FILM, MANUFACTURING METHOD THEREFOR, AND ELECTROLYTE COMPOSITION USED THEREFOR

(71) Applicant: SKC CO., LTD., Gyeonggi-do (KR)

(72) Inventors: Seungbae OH, Gyeonggi-do (KR); Yongsang LA, Gyeonggi-do (KR); Byeonguk AHN, Gyeonggi-do (KR); Seonghwan LEE, Gyeonggi-do (KR)

(21) Appl. No.: 19/489,266

(22) PCT Filed: Jun. 19, 2024
(86) PCT No.: PCT/KR2024/008447

§ 371 Date: Dec. 2, 2025

(30) Foreign Application Priority Data
Jun. 20, 2023 (KR) 10-2023-0079321

(51) Int. Cl. G02F 1/1516; G02F 1/15

(52) U.S. Cl. CPC G02F 1/15165; G02F 2001/164

(57) ABSTRACT

An electrochromic film according to an embodiment comprises a base layer, a conductive layer, a color change layer, and an electrolyte layer, wherein the electrolyte layer comprises a repeating unit having a specific structure, thereby exhibiting a significantly faster transmittance change rate than conventional electrochromic films, and having excellent heat resistance and durability even in a severe environment of high temperature and humidity of a specific temperature or higher and/or a specific humidity or higher, thus improving color change rate and performance. Therefore, the electrochromic film can be applied to electrochromic devices and also as a smart window or the like in various fields such as electronic devices, automobiles, constructions, and the like.

### TECHNICAL FIELD

Embodiments relate to an electrochromic film having excellent thermal resistance and durability, to a process for preparing the same, and to an electrolyte composition used in the electrochromic film.

### BACKGROUND ART

In recent years, as interest in environmental protection has increased, interest in technologies that enhance energy efficiency is also increasing. As an example, research and development on technologies such as smart windows and energy harvesting are being actively conducted. A smart window among them refers to an active control technology that adjusts the degree of transmission of light coming from the outside to enhance energy efficiency and to provide a pleasant environment to the users. It is a fundamental technology that can be commonly applied to various industrial fields. A smart window is based on electrochromism. Electrochromism is a phenomenon in which an electrochemical oxidation or reduction reaction takes place in response to an applied voltage, and the color or optical properties such as light transmittance that are inherent in an electrochromically active material are altered accordingly.

In general, an electrochromic film used in such electrochromic devices comprises a base layer, a conductive layer, a chromic layer, and an electrolyte layer. Here, the electrolyte layer acts as a transport path for lithium ions, and thus it greatly contributes to the performance and durability of an electrochromic film. The electrolyte layer is formed by coating an electrolyte composition containing a polymer resin and a lithium salt on a chromic layer and curing it through heat or UV.

However, when the electrolyte layer is heated, the skeletal structure of the electrolyte layer may shrink, or it may be thermally cured to a slight extent, which narrows the space where lithium ions can be transported, resulting in a slow chromic speed. In particular, when exposed to a harsh environment with high temperature and high humidity, this shrinkage phenomenon may be aggravated, thereby hindering the transport of lithium ions and deteriorating thermal resistance and durability, which may lead to problems such as deteriorated chromic performance.

### PRIOR ART DOCUMENT

(Patent Document 1) Korean Patent No. 1862200 (May 23, 2018)

### DISCLOSURE OF INVENTION

### Technical Problem

The present invention has been devised to solve the problems of the prior art described above.

An object of the present invention is to provide an electrochromic film in which excessive curing of an electrolyte layer is prevented, and the skeletal structure of the electrolyte layer is stably maintained at the same time even in a harsh environment with high temperature and high humidity, so that lithium ions can be transported smoothly, and thermal resistance and durability are excellent, thereby enhancing the chromic speed and performance; and a process for preparing the same.

An object of the present invention is to provide an electrolyte composition to be used in the above electrochromic film.

### Solution to Problem

In order to accomplish the above object, an embodiment provides an electrochromic film that comprises a base layer, a conductive layer, a chromic layer, and an electrolyte layer, wherein the electrolyte layer comprises a repeat unit of the following Formula 1:

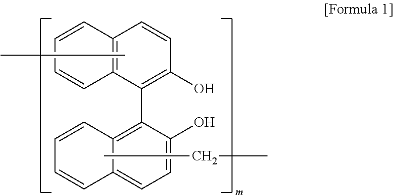

In Formula 1, m is 1 to 20.

Another embodiment provides a process for preparing an electrochromic film that comprises forming a base layer, a conductive layer on the base layer, a chromic layer on the conductive layer, and an electrolyte layer on the chromic layer, wherein the electrolyte layer is formed using an electrolyte composition comprising a polymer resin, a lithium salt compound, and a curing regulator, and the curing regulator comprises a repeat unit of the above Formula 1.

Another embodiment provides an electrolyte composition that comprises a polymer resin, a lithium salt compound, and a curing regulator, wherein the curing regulator comprises a repeat unit of the above Formula 1.

### Advantageous Effects of Invention

The electrolyte layer contained in the electrochromic film according to an embodiment comprises a repeat unit of a specific structure, whereby it can exhibit a significantly faster rate of change in transmittance than those of conventional ones. It has excellent thermal resistance and durability even in a harsh environment with high temperature and high humidity above a specific temperature and/or above a specific humidity, whereby it can enhance chromic performance.

Accordingly, the electrochromic film can be applied as a smart window in various fields such as electronic devices, automobiles, and architecture.

### BRIEF DESCRIPTION OF DRAWINGS

FIG. 1 schematically shows a cross-section of an electrochromic film according to an embodiment.

FIG. 2 schematically shows a cross-section of an electrochromic film according to another embodiment.

FIG. 3 schematically shows a cross-section of an electrochromic film according to another embodiment.

FIG. 4 schematically shows a cross-section of an electrochromic film according to another embodiment.

FIG. 5 schematically shows a cross-section of an electrochromic film according to another embodiment.

FIG. 6 schematically shows a process for preparing an electrochromic film according to an embodiment.

FIG. 7 shows a method of measuring the transmittance of an electrochromic film according to an embodiment.

FIG. 8 shows a point for measuring the transmittance of an electrochromic film according to an embodiment.

FIG. 9a is a perspective view conceptually showing a window to which an electrochromic film according to an embodiment is applied.

FIG. 9b is a cross-sectional view taken along line A-A′ in FIG. 9a and an enlarged view thereof.

### EXPLANATION OF REFERENCE NUMERALS

10: window, 100: electrochromic film, 110: base layer (first base layer), 111: first-A primer layer 112: first-B primer layer, 120: first barrier layer, 121: first-A barrier layer, 122: first-B barrier layer, 123: first-C barrier layer, 130: light transmission variable structure, 131: conductive layer (first conductive layer), 133: chromic layer (first chromic layer), 135: electrolyte layer, 137: second chromic layer, 139: second conductive layer, 140: second barrier layer, 141: second-A barrier layer 142: second-B barrier layer 143: second-C barrier layer, 150: second base layer, 151: second-A primer layer, 152: second-B primer layer, 160: release film layer, 161: adhesive layer, 170: hard coating layer, 210: light source, 220: measuring device, A-A′: cutting line, L1: length of electrochromic film, P1: center point of electrochromic film, P2 to P5: edge points of electrochromic film

### BEST MODE FOR CARRYING OUT THE INVENTION

Hereinafter, various embodiments and examples of the present invention will be described in detail by referring to the drawings.

In the description of the present specification, if it is determined that a detailed description of a relevant known constitution or function may obscure the subject matter of the present invention, the detailed description thereof will be omitted. In addition, for the sake of description, the sizes of individual elements in the appended drawings may be exaggeratedly depicted or omitted, and they may differ from the actual sizes.

In the present specification, in the case where an element is mentioned to be formed, connected, or combined on or under another element, it means all of the cases where one element is directly, or indirectly through another element, formed, connected, or combined with another element. In addition, it should be understood that the criterion for the terms on and under for each component may vary depending on the direction in which the object is observed.

In this specification, terms referring to the respective components are used to distinguish them from each other and are not intended to limit the scope of the present invention. In addition, in the present specification, a singular expression is interpreted to cover a plural number as well unless otherwise specified in the context.

In the present specification, the term “comprising” is intended to specify a particular characteristic, region, step, process, element, and/or component. It does not exclude the presence or addition of any other characteristic, region, step, process, element, and/or component, unless specifically stated to the contrary.

Throughout the present specification, the terms first, second, and the like are used to describe various components. But the components should not be limited by the terms. The terms are used for the purpose of distinguishing one component from another.

All numbers and expressions related to the quantities of components, reaction conditions, and the like used herein are to be understood as being modified by the term “about,” unless otherwise indicated.

### <Electrochromic Film>

In an embodiment, there is provided an electrochromic film, which comprises a base layer, a conductive layer, a chromic layer, and an electrolyte layer, wherein the electrolyte layer comprises a repeat unit of the following Formula 1:

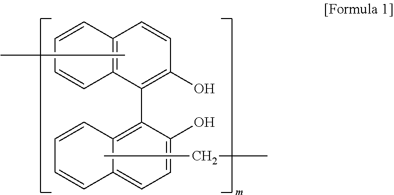

In Formula 1, m is 1 to 20.

In the repeat unit of the above Formula 1, the bond in each naphthol ring that indicates the connection to the next repeat unit, other than the bond that connects the two naphthol rings, may be understood as being connected to any one of the carbon atoms constituting each naphthol ring.

The electrolyte layer contained in the electrochromic film according to an embodiment comprises a repeat unit of a specific structure, whereby it can exhibit a significantly faster rate of change in transmittance than those of conventional ones. It has excellent thermal resistance and durability even in a harsh environment with high temperature and high humidity above a specific temperature and/or above a specific humidity, whereby it can enhance chromic performance.

Hereinafter, the layer configuration, properties, effects, and uses of the electrochromic film will be described in more detail.

### Layer Configuration of the Electrochromic Film

The electrochromic film comprises a base layer, a conductive layer, a chromic layer, and an electrolyte layer.

Specifically, the electrochromic film comprises a base layer and a light transmission variable structure, capable of adjusting coloration and decoloration in response to the application of a voltage, on the base layer. The light transmission variable structure may comprise a conductive layer, a chromic layer, and an electrolyte layer.

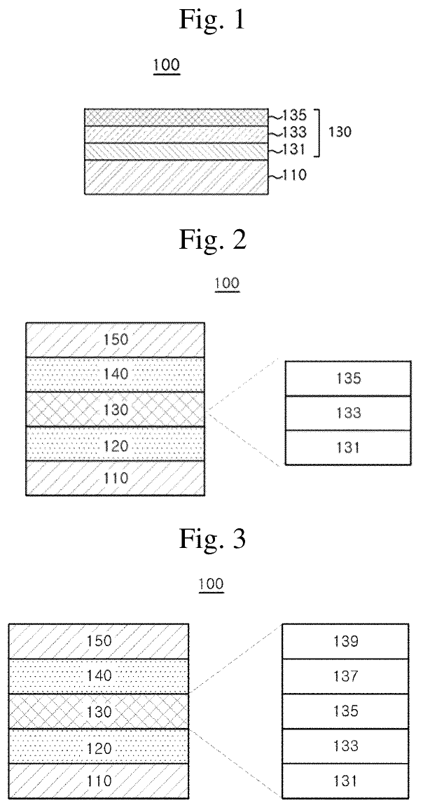

FIGS. 1 to 5 each schematically show a cross-section of an electrochromic film according to various embodiments.

Referring to FIG. 1, the electrochromic film (100) according to an embodiment may sequentially comprise a base layer (110) and a light transmission variable structure (130) comprising a conductive layer (131), a chromic layer (133), and an electrolyte layer (135).

In addition, the electrochromic film may comprise one, two, or more base layers, one, two, or more conductive layers, and one, two, or more chromic layers. For example, the electrochromic film may comprise a pair of base layers, a pair of conductive layers, and a pair of chromic layers.

In addition, the electrochromic film may have various configurations modified or added based on the base layer, conductive layer, chromic layer, and electrolyte layer.

Referring to FIG. 2, the electrochromic film (100) according to another embodiment may further comprise a first barrier layer (120) between the first base layer (110) and the light transmission variable structure (130) comprising the conductive layer (131), the chromic layer (133), and the electrolyte layer (135), and it may further comprise a second barrier layer (140) between a second base layer (150) and the light transmission variable structure (130).

Referring to FIG. 3, the electrochromic film (100) according to another embodiment sequentially comprises a first base layer (110), a first barrier layer (120), a light transmission variable structure (130), a second barrier layer (140), and a second base layer (150), wherein the light transmission variable structure (130) may sequentially comprise a first conductive layer (131), a first chromic layer (133), an electrolyte layer (135), a second chromic layer (137), and a second conductive layer (139).

When a voltage is applied to the first conductive layer (131) and the second conductive layer (139), the overall light transmittance may increase or decrease due to specific ions or electrons transported from the second chromic layer (137) to the first chromic layer (133) through the electrolyte layer (135). For example, when the light transmittance of the second chromic layer (137) decreases, the light transmittance of the first chromic layer (133) may also decrease. In addition, when the light transmittance of the second chromic layer (137) increases, the light transmittance of the first chromic layer (133) may also increase.

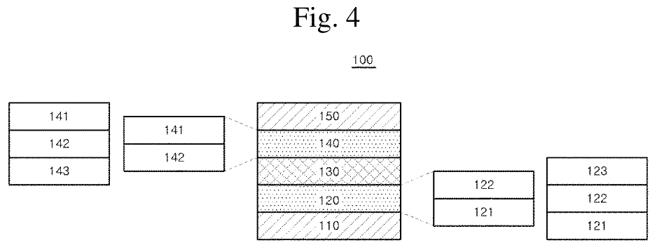

Referring to FIG. 4, the electrochromic film (100) according to another embodiment sequentially comprises a first base layer (110), a first barrier layer (120), a light transmission variable structure (130), a second barrier layer (140), and a second base layer (150), wherein the first barrier layer (120) may sequentially comprise a first-A barrier layer (121) and a first-B barrier layer (122), or it may sequentially comprise a first-A barrier layer (121), a first-B barrier layer (122), and a first-C barrier layer (123).

Specifically, a first-A barrier layer (121) and a first-B barrier layer (122) may be sequentially laminated, or a first-A barrier layer (121), a first-B barrier layer (122), and a first-C barrier layer (123) may be sequentially laminated, on the first base layer (110).

In addition, the second barrier layer (140) may comprise a second-A barrier layer (141) and a second-B barrier layer (142), or it may comprise a second-A barrier layer (141), a second-B barrier layer (142), and a second-C barrier layer (143). Specifically, a second-A barrier layer (141) and a second-B barrier layer (142) may be sequentially laminated, or a second-A barrier layer (141), a second-B barrier layer (142), and a second-C barrier layer (143) may be sequentially laminated, under the second base layer (150).

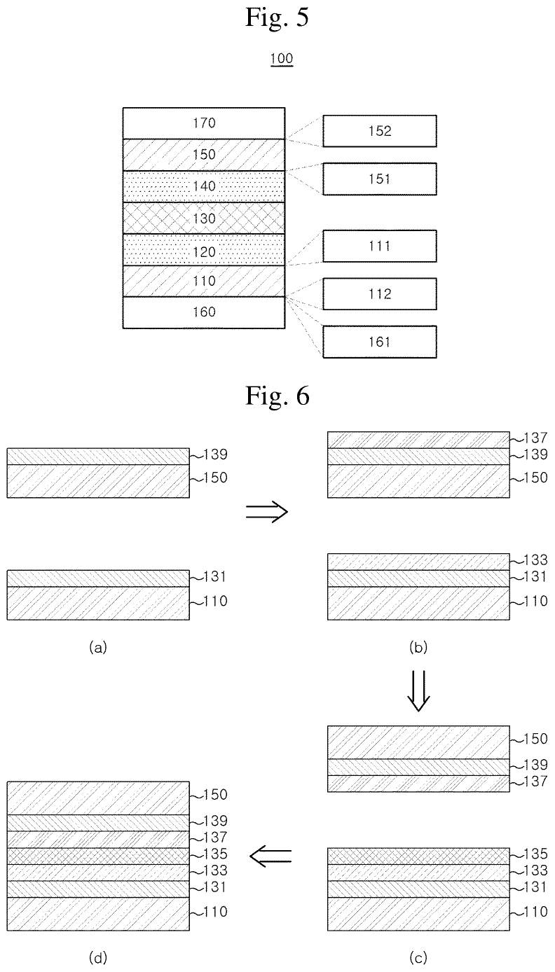

Referring to FIG. 5, the electrochromic film (100) according to another embodiment may further comprise a release film layer (160) on the side of the first base layer (110) opposite to the side on which the first barrier layer (120) is laminated. An adhesive layer (161) may be formed on one side of the release film layer. In addition, a primer layer (111, 112, 151, 152) may be laminated on one side or both sides of the first base layer (110) or the second base layer (150). In addition, the electrochromic film (100) may further comprise a hard coating layer (170) on the side of the second base layer (150) opposite to the side on which the second barrier layer (140) is laminated.

The electrochromic film (100) may have a thickness of 100 μm to 1,000 μm. Specifically, the thickness of the electrochromic film (100) may be 100 μm or more, 150 μm or more, 200 μm or more, 300 μm or more, or 400 μm or more, and may be 1,000 μm or less, 900 μm or less, 800 μm or less, 700 μm or less, or 600 μm or less. Specifically, the thickness of the electrochromic film (100) may be 100 μm to 1,000 μm, 100 μm to 800 μm, 100 μm to 700 μm, 200 μm to 700 μm, 200 μm to 600 μm, 300 μm to 800 μm, 300 μm to 700 μm, or 400 μm to 600 μm, but it is not limited thereto.

The electrochromic film (100) may have 4 or more layers, 5 or more layers, 6 or more layers, or 7 or more layers.

The features, such as components and properties of each layer of the electrochromic film described above, may be combined with each other.

Hereinafter, each constitutional layer will be described in detail.

### Electrolyte Layer

The electrochromic film according to an embodiment comprises an electrolyte layer.

The electrolyte layer may be a layer that acts as a transport path for lithium ions, and it may be a layer that has a significant impact on durability and chromic performance such as chromic speed.

Specifically, referring back to FIG. 3, the electrolyte layer (135) may be located between the first chromic layer (133) and the second chromic layer (137). It may be formed by coating an electrolyte composition comprising a polymer resin, a lithium salt compound, and a curing regulator on one side of the chromic layer, for example, one of the first chromic layer (133) and the second chromic layer (137), and then curing it by heat or UV.

The electrolyte layer comprises a repeat unit of the following Formula 1:

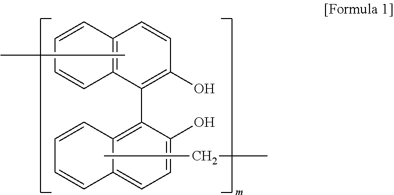

In Formula 1, m is 1 to 20.

The electrolyte layer according to an embodiment comprises at least one repeat unit of the above Formula 1, specifically, 1,1′-bi-2-naphthol, having a bulky aromatic compound structure, linked to a methylene (CH₂) group. As a result, a sufficient space is formed between the structures where two naphthols are connected in the above repeat unit for the smooth transport of lithium ions, and the repeat unit of the above Formula 1 acts as a pillar of the electrolyte layer at the same time, thereby stably maintaining the skeletal structure of the electrolyte layer and forming the electrolyte layer more firmly.

In addition, the electrolyte layer can further enhance the performance of an electrochromic film; in particular, it can further enhance durability and thermal resistance, as compared with an electrolyte layer comprising a repeat unit of an aliphatic compound structure. Therefore, it has great advantages of maintaining excellent chromic performance stably, such as showing a fast change rate of transmittance even in a harsh environment with high temperature and high humidity.

In Formula 1, m may be 1 to 20, 2 to 20, 3 to 20, 5 to 20, 5 to 18, 5 to 16, or 5 to 15.

When m in Formula 1 satisfies the above range, the role of the desired electrolyte layer can be readily implemented, thereby enhancing the chromic performance.

According to an embodiment, the electrolyte layer may comprise only the repeat unit of the above Formula 1. In such a case, the electrolyte layer can be strengthened while a transport path for lithium ions is secured, whereby excellent electrochromic performance can be maintained even after exposure to a harsh environment with high temperature and high humidity.

In addition, according to an embodiment, the repeat unit of the above Formula 1 can be combined with other compounds.

For example, the methylene (CH₂) connected to 1,1′-bi-2-naphthol in the repeat unit of the above Formula 1 may be formed as combined with an aromatic compound containing an alkyl group having 5 to 20 carbon atoms. In addition, the aromatic compound may be substituted with a hydroxy (—OH) group.

The electrolyte layer according to an embodiment may further comprise a repeat unit of the following Formula 2 while it comprises the repeat unit of the above Formula 1:

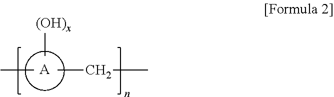

In Formula 2, A is an aromatic group, n is 1 to 30, and x is 1 or 2.

As the electrolyte layer according to an embodiment further comprises a repeat unit of the above Formula 2, it can additionally impart flexibility to the electrolyte layer firmly formed by the repeat unit of the above Formula 1. In such a case, it is possible to achieve a faster change rate of transmittance and to further enhance thermal resistance and durability even in a harsh environment with high temperature and/or high humidity above a certain temperature and/or above a certain humidity, thereby further enhancing chromic performance.

In Formula 2, A may comprise an aromatic group having 5 to 20 carbon atoms, an aromatic group having 5 to 12 carbon atoms, an aromatic group having 5 to 10 carbon atoms, or an aromatic group having 5 to 8 carbon atoms.

In Formula 2, n may be 1 to 30, 2 to 30, 5 to 30, 6 to 30, 8 to 30, or 10 to 30.

In Formula 2, x may be 1 or 2, for example, x may be 1.

Specifically, Formula 2 may comprise a repeat unit of the following Formula 2-1:

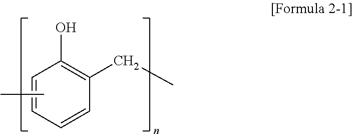

The electrolyte layer according to an embodiment may comprise a repeat unit of the following Formula 3.

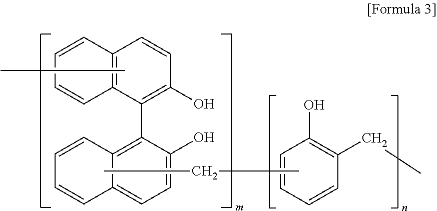

In Formula 3, m and n are each as described above.

When the electrolyte layer comprises a repeat unit of the above Formula 3, a firm electrolyte layer can be formed, and a transport path for lithium ions is stably secured, by virtue of the bulky structure of the repeat unit of the above Formula 1; and, at the same time, the repeat unit of the above Formula 2, which is less bulky than the repeat unit of the above Formula 1, can impart flexibility, thereby allowing smoother transport of lithium ions. As a result, thermal resistance, durability, and chromic performance can be further enhanced.

Meanwhile, when the electrolyte layer comprises a repeat unit of the above Formula 3, the content ratio of the repeat unit of the above Formula 1 and the repeat unit of the above Formula 2 may be important.

The electrolyte layer may comprise the repeat unit of the above Formula 1 and the repeat unit of the above Formula 2 at a molar ratio of 100:0 to 100:50. Specifically, the molar ratio of the repeat unit of the above Formula 1 and the repeat unit of the above Formula 2 in the electrolyte layer may be 100:0 to 100:40, 100:0 to 100:30, 100:0 to 100:25, 100:10 to 100:50, 100:10 to 100:40, 100:10 to 100:30, 100:15 to 100:50, 100:15 to 100:40, 100:15 to 100:30, 100:20 to 100:50, 100:20 to 100:40, 100:20 to 100:30, 100:25 to 100:50, 100:25 to 100:40, 100:25 to 100:30, or 100:20 to 100:25.

When the electrolyte layer comprises the repeat unit of the above Formula 1 and the repeat unit of the above Formula 2 in the above molar ratio range, it may be more advantageous in producing the desired effect.

If the electrolyte layer comprises the repeat unit of the above Formula 2 excessively or comprises only the repeat unit of the above Formula 2, there is a limit to securing the formation of a space that facilitates the transport of lithium ions within the electrolyte layer due to the lack of the repeat unit of the above bulky Formula 1, and it may be difficult to support the skeletal structure of the electrolyte layer, making it difficult to produce the desired effect. In particular, thermal resistance and durability are reduced, thereby significantly deteriorating the transmittance performance in an environment with high temperature and high humidity.

In addition, the electrolyte layer may comprise a polymer resin. Specifically, the polymer resin may be selected from the group consisting of an acrylic-based resin, an epoxy-based resin, a silicone-based resin, a polyimide-based resin, or a polyurethane-based resin, but it is not limited thereto. In such an event, the acrylic-based resin may be a thermosetting acrylic-based resin, a photocurable acrylic-based resin, or the like. The polyurethane-based resin may be a thermosetting polyurethane-based resin, a photocurable polyurethane-based resin, an aqueous polyurethane-based resin, or the like. In addition, the electrolyte layer may comprise a lithium salt compound.

The lithium salt compound may be selected from the group consisting of LiClO₄, LiBF₄, LiAsF₆, LiPF₆, LIBOB (lithium bis(oxalato) borate), LiDODFP (lithium difluorobis(oxalato)phosphate), and LITFSI (lithium bis(trifluoromethane) sulfonimide), but it is not limited thereto.

The specific contents and characteristics of the respective components contained in the electrolyte layer will be described in more detail with respect to the electrolyte composition described below.

The electrolyte layer may be formed by coating a liquid or gel-like electrolyte composition on the chromic layer, specifically, on the first chromic layer or the second chromic layer. Specifically, the electrolyte layer may be formed by coating an electrolyte composition on one side of any one of the first chromic layer or the second chromic layer by a wet coating method and then drying it. If the electrolyte layer is coated by a wet coating method, the thickness of the coating film can be increased or the thickness of the coating film can be easily controlled, which is advantageous from the viewpoint of enhancing ionic conductivity or chromic speed. On the other hand, if a sputtering coating method, rather than a wet coating method, is used for the electrolyte layer, there is a risk that the coating film may be easily broken due to the formation of a thin film, or the ionic conductivity may be reduced even if there is no damage.

The electrolyte layer may have an ionic conductivity of 10⁻³ mS/cm or more. Specifically, the ionic conductivity of the electrolyte layer may be 10⁻³ mS/cm to 10³ mS/cm or 10⁻³ mS/cm to 10² mS/cm, but it is not limited thereto. If the ionic conductivity of the electrolyte layer is within the above range, the desired light transmission variable performance can be achieved, and it is advantageous from the viewpoint of flexibility and reliability in an environment with high temperature and high humidity.

The electrolyte layer may have an adhesive strength of 200 g/inch or more. Specifically, the adhesive strength of the electrolyte layer may be 200 g/inch to 900 g/inch or 200 g/inch to 700 g/inch, but it is not limited thereto. If the adhesive strength of the electrolyte layer is within the above range, it adheres well to both substrates so that the performance of the electrochromic film and an electrochromic device can be smoothly exhibited.

The electrolyte layer may have a thickness of 30 μm to 200 μm, 50 μm to 200 μm, 50 μm to 150 μm, 70 μm to 130 μm, 80 μm to 120 μm, or 100 μm to 120 μm.

When the thickness of the electrolyte layer satisfies the above range, it may be more advantageous for achieving the desired effect. In particular, thermal resistance and durability are imparted to the electrochromic film, and, at the same time, the transport path of ions between the first chromic layer and the second chromic layer is secured in an appropriate length, whereby an appropriate speed in the light transmission change performance can be achieved.

If the thickness of the electrolyte layer exceeds the above range, it may take a long time for the chromic change, which may hinder the achievement of the desired effect. If the thickness of the electrolyte layer is less than the above range, the desired effect may be minimal.

### Chromic Layer

The electrochromic film according to an embodiment comprises a chromic layer.

The chromic layer is a layer in which the light transmittance changes, and it may be a layer that imparts a change in light transmittance to the electrochromic film.

The chromic layer may comprise a first chromic layer and a second chromic layer.

The first chromic layer and the second chromic layer may each comprise an electrochromic material having a color development characteristic complementary to each other. The complementary color development characteristic means that the types of reaction by which the electrochromic materials develop color are different from each other.

For example, if an oxidizing chromic material is used in the first chromic layer, a reducing chromic material may be used in the second chromic layer. If a reducing chromic material is used in the first chromic layer, an oxidizing chromic material may be used in the second chromic layer.

Specifically, the first chromic layer may comprise a reducing chromic material, and the second chromic layer may comprise an oxidizing chromic material.

The oxidizing chromic material refers to a material that changes color when an oxidation reaction takes place, and the reducing chromic material refers to a material that changes color when a reduction reaction takes place.

That is, in a chromic layer to which an oxidizing chromic material has been applied, if an oxidation reaction takes place, a coloration reaction would take place; and if a reduction reaction takes place, a decoloration reaction would take place. In addition, in a chromic layer to which a reducing chromic material has been applied, if a reduction reaction takes place, a coloration reaction would take place; and if an oxidation reaction takes place, a decoloration reaction would take place.

As specific examples, the reducing chromic material may be one or more selected from the group consisting of titanium oxide (TiO), vanadium oxide (V₂O₅), niobium pentoxide (Nb₂O₅), chromium oxide (Cr₂O₃), manganese oxide (MnO₂), iron oxide (FeO₂), cobalt oxide (CoO₂), nickel oxide (NiO₂), rhodium oxide (RhO₂), tantalum oxide (Ta₂O₅), iridium oxide (IrO₂), tungsten oxide (WO₂, WO₃, W₂O₃, W₂O₅), viologen, and combinations thereof, but it is not limited thereto.

As specific examples, the oxidizing chromic material may be one or more selected from the group consisting of nickel oxide (e.g., NiO, NiO₂), manganese oxide (e.g., MnO₂), cobalt oxide (e.g., CoO₂), iridium-magnesium oxide, nickel-magnesium oxide, titanium-vanadium oxide, a Prussian blue-based pigment, and combinations thereof, but it is not limited thereto. The Prussian blue-based pigment is a dark blue pigment and, for example, may comprise a compound having a formula of Fe₄ (Fe(CN)₆)₃.

The first chromic layer and the second chromic layer may each further comprise a polymer resin. The polymer resin may be a resin that has flexibility and is not limited to a specific type. For example, the polymer resin may be a urethane acrylic-based resin, a silicone-based resin, an acrylic-based resin, an ester-based resin, an epoxy-based resin, a phenolic-based resin, a polyurethane-based resin, a polyimide-based resin, or an ethylene vinyl acetate-based resin, but it is not limited thereto.

In addition, the polymer resin may have a number average molecular weight of 50 to 10,000 g/mole. Specifically, the number average molecular weight of the polymer resin may be 100 to 10,000 g/mole, 200 to 10,000 g/mole, or 500 to 10,000 g/mole, but it is not limited thereto.

The first chromic layer and the second chromic layer may each comprise the polymer resin in an amount of 0.1 to 15 parts by weight, 1 to 15 parts by weight, 2 to 15 parts by weight, 3 to 10 parts by weight, 3 to 7 parts by weight, or 0.1 to 5 parts by weight, based on 100 parts by weight of the reducing or oxidizing chromic material contained therein, respectively. Within the above preferred range, the reducing or oxidizing chromic material can be stably attached to an adjacent layer to achieve smooth light transmittance variable performance. In addition, it may be more advantageous in suppressing changes in visible light transmittance that may occur after repeated bending or long-term power off

Meanwhile, referring back to FIG. 3, the light transmission variable structure (130) comprises at least one of the first chromic layer (133) and the second chromic layer (137), respectively. It may comprise two or more of the first chromic layer or the second chromic layer made of different materials, respectively, as needed.

The first chromic layer (133) may have an initial transmittance of 90% or more. Within the above range, the optical performance of the electrochromic film can be further enhanced. Meanwhile, the second chromic layer (137) may have an initial transmittance of 50% or less. Specifically, that the initial transmittance satisfies the above range means that it exhibits a dark blue or pale indigo color when viewed with the naked eye.

The first chromic layer (133) may have a thickness of 100 nm to 1,000 nm, 200 nm to 1,000 nm, 200 nm to 800 nm, 200 nm to 700 nm, 300 nm to 700 nm, or 300 nm to 600 nm. When the thickness of the first chromic layer is within the above preferred range, a change in light transmittance of the light transmission variable structure may impart significant variability of light transmittance to the entire electrochromic film. It may be more advantageous in suppressing changes in visible light transmittance that may occur after repeated bending or long-term power off.

The second chromic layer (137) may have a thickness of 100 nm to 1,000 nm, 100 nm to 800 nm, 100 nm to 600 nm, 100 nm to 500 nm, 100 nm to 400 nm, 200 nm to 800 nm, or 300 nm to 800 nm, but it is not limited thereto. When the thickness of the second chromic layer (137) is within the above preferred range, the film withstands external impacts well, and an appropriate amount of ions may be retained. At the same time, it is advantageous for making an electrochromic film thin, securing the flexibility thereof, and achieving excellent light transmission change characteristics.

The thickness ratio of the first chromic layer (133) and the second chromic layer (137) may be 50:50 to 80:20, 55:45 to 75:25, or 60:40 to 70:30. Within the above preferred thickness ratio range, the color change range from transparent to dark can be wider, and the color change time can be shortened.

The preparation process of the first chromic layer (133) and the second chromic layer (137) is not particularly limited, but a wet coating method can be used to form them to a certain thickness or more. Since wet coating is capable of forming a chromic layer with a thickness of 100 nm or more, it is advantageous in achieving both excellent light transmission variable performance and flexibility. Specifically, the first chromic layer (133) may be formed by coating a raw material on one side of the first conductive layer (131) by a wet coating method and then drying it. In addition, the second chromic layer (137) may be formed by coating a raw material on one side of the second conductive layer (139) by a wet coating method and then drying it. The solvent used in the wet coating may be a non-aromatic solvent or an aromatic solvent, specifically, ethanol, acetone, toluene, or the like, but it is not limited thereto.

### Conductive Layer

The electrochromic film according to an embodiment comprises a conductive layer.

The conductive layer is an electrode layer and may comprise a first conductive layer and a second conductive layer.

The first conductive layer and the second conductive layer may each comprise a transparent electrode or a reflective electrode. In an embodiment, one of the first conductive layer and the second conductive layer may be a transparent electrode, and the other may be a reflective electrode. In another embodiment, both the first conductive layer and the second conductive layer may be transparent electrodes.

Referring back to FIG. 3, the first conductive layer (131) may be formed on the first base layer (110) or the first barrier layer (120) by a sputtering deposition method. In addition, the second conductive layer (139) may be formed on the second base layer (150) or the second barrier layer (140) by a sputtering deposition method.

The transparent electrode may be made of a material having high transmittance of light and low sheet resistance, along with penetration resistance, and it may be formed in the shape of an electrode plate.

The transparent electrode may comprise one, for example, selected from the group consisting of indium-tin oxide (ITO), zinc oxide (ZnO), indium-zinc oxide (IZO), and combinations thereof.

The reflective electrode, for example, may comprise at least one selected from the group consisting of silver (Ag), aluminum (Al), copper (Cu), molybdenum (Mo), gold (Au), tungsten (W), chromium (Cr), and combinations thereof.

The first conductive layer (131) and the second conductive layer (139) may each have a thickness of 100 nm to 500 nm, 100 nm to 400 nm, 100 nm to 300 nm, or 150 nm to 250 nm, but it is not limited thereto.

The first conductive layer and the second conductive layer may each be a transparent electrode and comprise indium-tin oxide (ITO).

Specifically, the first conductive layer and the second conductive layer may each comprise indium oxide:tin oxide at a mass ratio of 70:30 to 98:2 or 80:20 to 97:3.

In addition, the first conductive layer and the second conductive layer may each have a surface resistance of 5 Ω/sq to 100 Ω/sq, 5 Ω/sq to 80 Ω/sq, 5 Ω/sq to 70 Ω/sq, or 5 Ω/sq to 50 Ω/sq, but it is not limited thereto.

### Base Layer

The electrochromic film according to an embodiment comprises a base layer.

The base layer serves to maintain transparency and durability and may comprise a polymer resin.

The base layer may comprise a first base layer and a second base layer.

The first base layer and the second base layer may each be a plastic film with flexibility.

Specifically, the first base layer and the second base layer may each comprise one or more polymer resins selected from the group consisting of polyethylene terephthalate (PET), polyethylene naphthalate (PEN), polycarbonate (PC), polyimide (PI), polycyclohexylenedimethylene terephthalate (PCT), polyethersulfone (PES), nylon, polymethyl methacrylate (PMMA), and cycloolefin polymer (COP), but it is not limited thereto. More specifically, the first base layer and the second base layer may each comprise polyethylene terephthalate (PET).

As the first base layer and the second base layer each comprise the polymer resin described above, it is possible to achieve an electrochromic film and an electrochromic device having both durability and flexibility.

The first base layer and the second base layer may each have a light transmittance of 80% or more for light having a wavelength of 550 nm. Specifically, the first base layer and the second base layer may each have a light transmittance of 85% or more or 90% or more for light having a wavelength of 550 nm. The first base layer and the second base layer may each have a haze of less than 2.0%, 1.8% or less, or 1.5% or less. The first base layer and the second base layer may each have an elongation of 80% or more. Specifically, the first base layer and the second base layer may each have an elongation of 90% or more, 100% or more, or 120% or more. As the first base layer and the second base layer each satisfy a light transmittance and a haze in the above ranges, transparency can be attained. As they satisfy an elongation in the above range, flexibility can be attained.

The first base layer and the second base layer may each have a thickness of 10 μm to 300 μm. Specifically, the thickness of the first base layer and the thickness of the second base layer may each be 50 μm to 250 μm, 70 μm to 200 μm, 80 μm to 200 μm, 100 μm to 200 μm, 100 μm to 190 μm, 100 μm to 180 μm, 120 μm to 200 μm, or 150 μm to 200 μm, but they are not limited thereto. As the thickness of the first base layer and the thickness of the second base layer are each within the above range, it is possible to render the electrochromic film an elongation and tensile strength at a specific level; and to provide a thin, lightweight, and flexible electrochromic film. It is also advantageous for being made thin.

### Barrier Layer

The electrochromic film according to an embodiment comprises a barrier layer.

The barrier layer serves to prevent the penetration of impurities, including moisture or gas, into the light transmission variable structure from the outside.

Referring back to FIG. 4, the first barrier layer (120) may be disposed on the first base layer (110), and the second barrier layer (140) may be disposed under the second base layer (150).

The first barrier layer (120) and the second barrier layer (140) may each comprise two or more layers. Specifically, the first barrier layer (120) and the second barrier layer (140) may each comprise two layers or three layers. For example, the first barrier layer (120) may comprise two layers, and the second barrier layer (140) may comprise two layers. Alternatively, the first barrier layer (120) may comprise three layers, and the second barrier layer (140) may comprise three layers.

The first barrier layer (120) may comprise a first-A barrier layer (121) and a first-B barrier layer (122), or it may comprise a first-A barrier layer (121), a first-B barrier layer (122), and a first-C barrier layer (123). Specifically, a first-A barrier layer (121) and a first-B barrier layer (122) may be sequentially laminated, or a first-A barrier layer (121), a first-B barrier layer (122), and a first-C barrier layer (123) may be sequentially laminated, on the first base layer (110).

In addition, the second barrier layer (140) may comprise a second-A barrier layer (141) and a second-B barrier layer (142), or it may comprise a second-A barrier layer (141), a second-B barrier layer (142), and a second-C barrier layer (143). Specifically, a second-A barrier layer (141) and a second-B barrier layer (142) may be sequentially laminated, or a second-A barrier layer (141), a second-B barrier layer (142), and a second-C barrier layer (143) may be sequentially laminated, under the second base layer (150).

In such a case, the first-A barrier layer and the second-A barrier layer may each have a thickness of 10 nm to 50 nm, 10 nm to 40 nm, or 10 nm to 30 nm, but it is not limited thereto. In addition, the first-B barrier layer and the second-B barrier layer may each have a thickness of 30 nm to 100 nm, 30 nm to 80 nm, 30 nm to 70 nm, or 40 nm to 60 nm, but it is not limited thereto.

The thickness ratio of the first-A barrier layer and the first-B barrier layer may be 1:2 to 1:10, 1:2.5 to 1:10, or 1:2.5 to 1:7.5, and the thickness ratio of the second-A barrier layer and the second-B barrier layer may be 1:2 to 1:10, 1:2.5 to 1:10, or 1:2.5 to 1:7.5, but they are not limited thereto. Within the above preferred thickness ratio ranges, the optical properties, refractive index, and long-term reliability, such as weatherability, of the film can be further enhanced.

The first barrier layer (120) and the second barrier layer (140) may each comprise at least one selected from the group consisting of metal oxides, metal nitrides, metal oxynitrides, metalloid oxides, metalloid nitrides, metalloid oxynitrides, and combinations thereof. Specifically, the first-A barrier layer may comprise a metal nitride or a metalloid nitride, and the first-B barrier layer may comprise a metal oxide or a metalloid oxide. In addition, the second-A barrier layer may comprise a metal nitride or a metalloid nitride, and the second-B barrier layer may comprise a metal oxide or a metalloid oxide.

Specifically, the first-A barrier layer may comprise silicon nitride (SiNx), and the first-B barrier layer may comprise silicon oxide (SiOx). In addition, the second-A barrier layer may comprise silicon nitride (SiNx), and the second-B barrier layer may comprise silicon oxide (SiOx). The Si:N ratio of the silicon nitride may be 1.0:0.8 to 1.0:1.2, and the Si:O ratio of the silicon oxide may be 1.0:1.7 to 1.0:2.3, but they are not limited thereto. Within the above preferred composition ranges, the desired performance can be achieved even with a thin barrier layer, and moisture penetration can be prevented as much as possible, which further enhances durability and long-term stability.

In addition, the first-A barrier layer, the first-B barrier layer, the second-A barrier layer, and the second-B barrier layer may each have a moisture permeability of 0.2 g/day·m² or less, 0.15 g/day·m² or less, or 0.1 g/day·m² or less, but it is not limited thereto. Within the above preferred thickness and moisture permeability ranges, the optical properties, refractive index, and long-term reliability, such as weatherability, of the film can be further improved.

In addition, the first-C barrier layer and the second-C barrier layer may each comprise an acrylic-based resin, an epoxy-based resin, a silicone-based resin, a polyimide-based resin, or a polyurethane-based resin.

The first barrier layer and the second barrier layer may be formed on the first base layer and the second base layer by vacuum deposition, respectively. The vacuum deposition may be carried out by physical vacuum deposition or chemical vacuum deposition. The physical vacuum deposition includes thermal vacuum deposition, E-beam vacuum deposition, and sputtering deposition.

As a specific example, the first barrier layer and the second barrier layer may be formed on each of the first base layer and the second base layer by sputtering deposition. The sputtering may be DC magnetron sputtering or AC magnetron sputtering. The DC magnetron sputtering may be, specifically, reactive plasma sputtering.

The raw material used in the deposition may be one or more of metals or metalloids, and the type is not particularly limited. For example, it may comprise at least one selected from magnesium (Mg), silicon (Si), indium (In), titanium (Ti), bismuth (Bi), germanium (Ge), and aluminum (Al).

The reaction gas used in the deposition may comprise oxygen (O₂) gas or nitrogen (N₂) gas. If oxygen gas is used as the reaction gas, a barrier layer comprising a metal oxide or a metalloid oxide may be formed. If nitrogen gas is used as the reaction gas, a barrier layer comprising a metal nitride or a metalloid nitride may be formed. If oxygen gas and nitrogen gas are appropriately mixed and used as the reaction gas, a barrier layer comprising a metal oxynitride or a metalloid oxynitride may be formed.

### Release Film Layer

Referring back to FIG. 5, the release film layer (160) may be formed on the side of the first base layer (110) opposite to the side on which the first barrier layer (120) is laminated.

The release film layer serves to protect the electrochromic film from external moisture or impurities during storage and transport of the electrochromic film. When the electrochromic film is later applied to a transparent window or the like, it may be used after the release film layer is removed, if necessary. The release film layer may particularly prevent a decrease in adhesive strength of the adhesive layer.

The release film layer may comprise a polyester-based resin comprising polyethylene terephthalate (PET), polyethylene naphthalate (PEN), or polycarbonate (PC).

Specifically, the release film layer may have a thickness of 10 μm to 100 μm, 10 μm to 80 μm, 10 μm to 50 μm, or 12 μm to 50 μm, but it is not limited thereto.

The release film layer may have a peel strength of 50 gf/inch or less. Specifically, it may be 3 gf/inch to 50 gf/inch or 10 gf/inch to 50 gf/inch, but it is not limited thereto.

An adhesive layer (161) may be formed on one side of the release film layer.

The adhesive layer (161) may comprise an acrylic-based resin, a silicone-based resin, a polyurethane-based resin, an epoxy-based resin, or a polyimide-based resin. Specifically, the adhesive layer may comprise an acrylic resin, in which case it is advantageous for enhancing the optical properties and durability.

The adhesive layer may have a blocking rate of UV rays (based on 400 nm) of 95% or more, 97% or more, 98% or more, or 99% or more, but it is not limited thereto.

In addition, the adhesive layer may have an initial adhesive strength of 0.5 N/inch to 8.0 N/inch, 1.0 N/inch to 7.0 N/inch, or 2.0 N/inch to 6.0 N/inch, but it is not limited thereto.

### Primer Layer

A primer layer may be laminated on one side or both sides of the first base layer. Specifically, referring back to FIG. 5, a first-A primer layer (111) may be laminated on one side of the first base layer (110), and a first-B primer layer (112) may be laminated on the other side.

In addition, a primer layer may be laminated on one side or both sides of the second base layer (150). Specifically, a second-A primer layer (151) may be laminated on one side of the second base layer (150), and a second-B primer layer (152) may be laminated on the other side.

In an embodiment, a primer layer may be interposed between the first barrier layer (120) and the first base layer (110). In addition, a primer layer may be interposed between the second barrier layer (140) and the second base layer (150).

The primer layers (first-A primer layer, first-B primer layer, second-A primer layer, and second-B primer layer) may each comprise an acrylic-based resin, a polyurethane-based resin, a silicone-based resin, or a polyimide-based resin.

The primer layers (first-A primer layer, first-B primer layer, second-A primer layer, and second-B primer layer) may each have a surface tension of 35 dyne/cm² or less or a surface tension of 30 dyne/cm² or less.

The primer layers (first-A primer layer, first-B primer layer, second-A primer layer, and second-B primer layer) may each have an adhesive strength of 3.0 gf/inch or more or an adhesive strength of 3.5 gf/inch or more.

The primer layer serves to impart adhesion between the base layer and the barrier layer or to improve the refractive index. In addition, the material forming the respective primer layers, surface tension, peel strength, and the like may be the same or different.

### Hard Coating Layer

Referring back to FIG. 5, the electrochromic film (100) may further comprise a hard coating layer (170) on the side of the second base layer (150) opposite to the side on which the second barrier layer (140) is laminated.

The hard coating layer (170) may comprise an acrylic-based resin, a silicone-based resin, a polyurethane-based resin, an epoxy-based resin, or a polyimide-based resin.

The hard coating layer may have a thickness of 1 μm to 10 μm, 2 μm to 8 μm, 2 μm to 6 μm, or 2 μm to 5 μm, but it is not limited thereto.

The hard coating layer may have a pencil hardness of 3H or higher, 4H or higher, or 5H or higher, but it is not limited thereto.

The hard coating layer serves to protect the electrochromic film from external impacts, and it may impart excellent hardness by virtue of its resistance to scratches.

In addition, as the thickness of the hard coating layer satisfies the above range, it is possible to achieve an electrochromic film having flexibility and excellent workability. If the thickness of the hard coating layer exceeds the above range, it is difficult to achieve flexibility. If the thickness of the hard coating layer is less than the above range, it may be vulnerable to external impacts.

### Physical Properties of the Electrochromic Film

As the electrochromic film according to an embodiment has the above characteristics, it can exhibit a significantly faster rate of change in transmittance than those of conventional ones. It has excellent thermal resistance and durability even in a harsh environment with high temperature and high humidity above a specific temperature and/or above a specific humidity, whereby it can enhance chromic performance.

According to an embodiment, for a specimen of the electrochromic film having a width of 300 mm, a length of 500 mm, and a thickness of 500 μm, when the average visible light transmittance is measured in the maximally colored state, the difference in transmittance (ΔT60_{dis}) in the maximally colored state represented by the following Equation 1-1 may be less than 3.5%:

$$Δ T {60}_{d i s} ( \% ) = \vert {T}_{dis 0} - {T}_{dis 60} \vert \qquad [ Equation 1 ‐ 1 ]$$

In Equation 1-1, T_{dis0} is the initial transmittance (%) of the specimen in the maximally colored state measured at room temperature, and T_{dis60} is the transmittance (%) of the specimen in the maximally colored state measured after exposure to a temperature of 60° C. and a humidity of 60% for 7 days.

Specifically, the difference (ΔT60_{dis}) between the transmittance (%) of the electrochromic film in the maximally colored state measured after exposure to a temperature of 60° C. and a humidity of 60% for 7 days and the initial transmittance (%) thereof in the maximally colored state measured at room temperature may be 3.2% or less, 3.0% or less, 2.8% or less, 2.5% or less, 2.0% or less, 1.8% or less, 1.5% or less, 1.2% or less, 1.0% or less, less than 1.0%, 0.9% or less, or 0.8% or less.

When the difference in transmittance (ΔT60_{dis}) of the electrochromic film satisfies the above range, it can maintain excellent electrochromic performance even in a harsh environment with high temperature and high humidity.

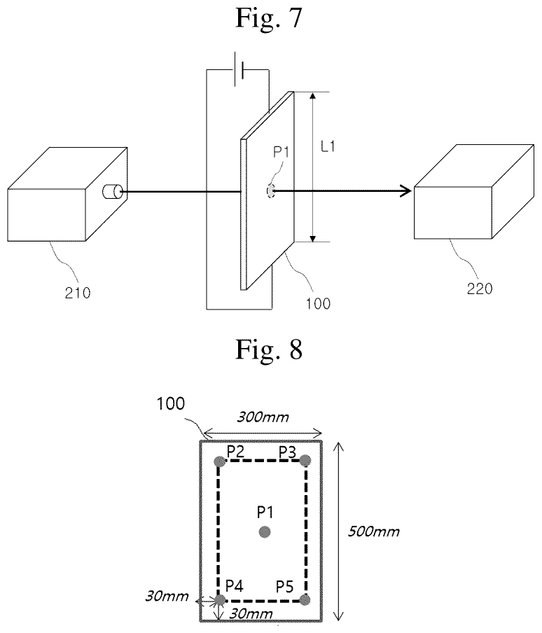

For example, referring to FIGS. 7 and 8, the measurement of the transmittance of the electrochromic film is performed by placing a specimen of the electrochromic film (100) between a light source (210) and a measuring device (220), measuring the visible light transmittance at a wavelength ranging from about 30 nm to 60 nm at the center point (P1) and four edge points (P2, P3, P4, and P5), excluding 30 mm from each end of the specimen of the electrochromic film (100), and obtaining the average visible light transmittance value of P1 to P5.

In addition, for example, the transmittance in the colored state may be measured over time while a voltage of −1.2 V is applied to a specimen in the maximally decolored state such that it changes to the maximally colored state. For example, the transmittance in the decolored state may be measured over time while a voltage of 1.2 V is applied to a specimen in the maximally colored state such that it changes to the maximally decolored state. In addition, the coloration test and the decoloration test may be performed repeatedly as needed.

In Equation 1-1, T_{dis0} may be, for example, 50% to 80%, 50% to 70%, 55% to 68%, 58% to 68%, 59% to 67%, or 60% to 67%.

In Equation 1-1, T_{dis60} may be, for example, 50% to 80%, 50% to 70%, 55% to 68%, 58% to 68%, 58% to 66%, 59% to 66%, or 60% to 66%.

When T_{dis0} and T_{dis60} each satisfy the above range, it may be more advantageous for achieving the desired effect.

In addition, according to another embodiment, for a specimen of the electrochromic film having a width of 300 mm, a length of 500 mm, and a thickness of 500 μm, when the average visible light transmittance is measured in the maximally decolored state, the difference in transmittance (ΔT60_{de}) in the maximally decolored state represented by the following Equation 1-2 may be 1.2% or less:

$$Δ T {60}_{d e} ( \% ) = \vert {T}_{de 0} - {T}_{de 60} \vert \qquad [ Equation 1 ‐ 2 ]$$

In Equation 1-2, T_{de0} is the initial transmittance (%) of the specimen in the maximally decolored state measured at room temperature, and T_{de60} is the transmittance (%) of the specimen in the maximally decolored state measured after exposure to a temperature of 60° C. and a humidity of 60% for 7 days.

Specifically, the difference (ΔT60_{de}) between the transmittance (%) of the electrochromic film in the maximally decolored state measured after exposure to a temperature of 60° C. and a humidity of 60% for 7 days and the initial transmittance (%) thereof in the maximally decolored state measured at room temperature may be 1.0% or less, less than 1.0%, 0.9% or less, 0.8% or less, 0.7% or less, 0.6% or less, or 0.5% or less.

When the difference in transmittance (ΔT60_{de}) of the electrochromic film satisfies the above range, it can maintain excellent electrochromic performance even in a harsh environment with high temperature and high humidity.

In Equation 1-2, T_{de0} may be, for example, 10% to 30%, 10% to 25%, 10% to 20%, 10% to 15%, 12% to 15%, or 12% to 14%.

In Equation 1-2, T_{de60} may be, for example, 10% to 30%, 10% to 25%, 10% to 20%, 10% to 18%, 12% to 16%, or 12% to 15%.

When T_{de0} and T_{de60} each satisfy the above range, it may be more advantageous for achieving the desired effect.

According to another embodiment, for a specimen of the electrochromic film having a width of 300 mm, a length of 500 mm, and a thickness of 500 μm, when the average visible light transmittance is measured in the maximally colored state, the difference in transmittance (ΔT60_{dis}) in the maximally colored state represented by the above Equation 1-1 may be less than 3.5%, and when the average visible light transmittance is measured in the maximally decolored state, the difference in transmittance (ΔT60_{de}) in the maximally decolored state represented by the above Equation 1-2 may be 1.2% or less.

According to another embodiment, for a specimen of the electrochromic film having a width of 300 mm, a length of 500 mm, and a thickness of 500 μm, when the average visible light transmittance is measured in the maximally colored state, the difference in transmittance (ΔT80_{dis}) in the maximally colored state represented by the following Equation 2-1 may be 6.0% or less:

$$Δ T {80}_{d i s} ( \% ) = \vert {T}_{dis 0} - {T}_{dis 80} \vert \qquad [ Equation 2 ‐ 1 ]$$

In Equation 2-1, T_{dis0} is the initial transmittance (%) of the specimen in the maximally colored state measured at room temperature, and T_{dis80} is the transmittance (%) of the specimen in the maximally colored state measured after exposure to a temperature of 80° C. for 7 days.

Specifically, the difference (ΔT80_{dis}) between the transmittance (%) of the electrochromic film in the maximally colored state measured after exposure to a temperature of 80° C. for 7 days and the initial transmittance (%) thereof in the maximally colored state measured at room temperature may be 5.0% or less, 4.0% or less, 3.0% or less, 2.8% or less, 2.5% or less, 2.0% or less, 1.8% or less, 1.5% or less, 1.4% or less, or 1.2% or less.

When the difference in transmittance (ΔT80_{dis}) of the electrochromic film satisfies the above range, it can maintain excellent electrochromic performance even in a harsh environment with a high temperature of 80° C. or higher.

In Equation 2-1, T_{dis0} is as described above.

In Equation 2-1, T_{dis80} may be, for example, 50% to 80%, 50% to 70%, 55% to 68%, 57% to 68%, or 58% to 66%.

When T_{dis80} satisfies the above range, it may be more advantageous for achieving the desired effect.

According to another embodiment, for a specimen of the electrochromic film having a width of 300 mm, a length of 500 mm, and a thickness of 500 μm, when the average visible light transmittance is measured in the maximally decolored state, the difference in transmittance (ΔT80_{de}) in the maximally decolored state represented by the following Equation 2-2 may be 2.0% or less:

$$Δ T {80}_{d e} ( \% ) = \vert {T}_{de 0} - {T}_{de 80} \vert \qquad [ Equation 2 ‐ 2 ]$$

In Equation 2-2, T_{de0} is the initial transmittance (%) of the specimen in the maximally decolored state measured at room temperature, and T_{de80} is the transmittance (%) of the specimen in the maximally decolored state measured after exposure to a temperature of 80° C. for 7 days.

Specifically, the difference (ΔT80_{de}) between the transmittance (%) of the electrochromic film in the maximally decolored state measured after exposure to a temperature of 80° C. for 7 days and the initial transmittance (%) thereof in the maximally decolored state measured at room temperature may be 2.0% or less, 1.9% or less, 1.8% or less, 1.7% or less, 1.6% or less, 1.5% or less, 1.4% or less, 1.3% or less, 1.2% or less, 1.1% or less, or 1.0% or less.

When the difference in transmittance (ΔT80_{de}) of the electrochromic film satisfies the above range, it can maintain excellent electrochromic performance even in a harsh environment with a high temperature of 80° C. or higher.

In Equation 2-2, T_{de0} is as described above.

In Equation 2-2, T_{de80} may be, for example, 10% to 30%, 10% to 25%, 10% to 20%, 10% to 18%, 12% to 18%, 12% to 16%, or 12% to 15%.

When T_{de80} satisfies the above range, it may be more advantageous for achieving the desired effect.

According to another embodiment, for a specimen of the electrochromic film having a width of 300 mm, a length of 500 mm, and a thickness of 500 μm, when the average visible light transmittance is measured in the maximally colored state, the difference in transmittance (ΔT80_{dis}) in the maximally colored state represented by the above Equation 2-1 may be 6.0% or less, and when the average visible light transmittance is measured in the maximally decolored state, the difference in transmittance (ΔT80_{de}) in the maximally decolored state represented by the above Equation 2-2 may be 2.0% or less.

According to another embodiment, for a specimen of the electrochromic film having a width of 300 mm, a length of 500 mm, and a thickness of 500 μm, the change rate of chromic speed (Dt) represented by the following Equation 3 may be 6.0% or less:

$$Change rate of chromic speed ( Dt , \% ) = \frac{\vert {dt}_{0} \vert - \vert {dt}_{60} \vert}{d {t}_{0}} \times 100 \% \qquad [ Equation 3 ]$$

In Equation 3, dt₀ is the time (seconds) required for the average visible light transmittance to reach 15% from 60% at room temperature, and dt₆₀ is the time (seconds) required for the average visible light transmittance to reach 15% from 60% after exposure to a temperature of 60° C. and a humidity of 60% for 7 days.

Specifically, the change rate of chromic speed (Dt), which is the percentage of the absolute value of the difference between the time (seconds) required for the average visible light transmittance to reach 15% from 60% at room temperature (dt₀) and the time (seconds) required for the average visible light transmittance to reach 15% from 60% after exposure to a temperature of 60° C. and a humidity of 60% for 7 days (dt₆₀), divided by dt₀, may be 5.0% or less, 4.5% or less, 4.0% or less, 3.5% or less, 3.0% or less, 2.9% or less, 2.8% or less, 2.5% or less, 2.0% or less, 1.0% or less, less than 1.0%, 0.9% or less, or 0.8% or less.

When the change rate of chromic speed (Dt) of the electrochromic film satisfies the above range, it can maintain excellent electrochromic performance even in a harsh environment with high temperature and high humidity.

In Equation 3, dt₀ may be 100 seconds to 165 seconds, 100 seconds to 160 seconds, 100 seconds to 155 seconds, 100 seconds to 150 seconds, 100 seconds to 145 seconds, 120 seconds to 165 seconds, 130 seconds to 165 seconds, 130 seconds to 150 seconds, 133 seconds to 145 seconds, 133 seconds to 143 seconds, or 133 seconds to 140 seconds.

In Equation 3, dt₆₀ may be 100 seconds to 170 seconds, 110 seconds to 165 seconds, 110 seconds to 160 seconds, 110 seconds to 155 seconds, 110 seconds to 150 seconds, 110 seconds to 148 seconds, 120 seconds to 165 seconds, 130 seconds to 165 seconds, 130 seconds to 150 seconds, 132 seconds to 148 seconds, 133 seconds to 147 seconds, or 133 seconds to 145 seconds.

When dt₀ and dt₀ each satisfy the above range, it may be more advantageous for achieving the desired effect.

According to another embodiment, the difference in time (Δdt) represented by the following Equation 3-1 may be 10 seconds or less:

$$Δ dt ( seconds ) = \vert {dt}_{0} - d {t}_{60} \vert \qquad [ Equation 3 ‐ 1 ]$$

In Equation 3-1, dt₀ and dt₆₀ are as defined above.

The difference in time (Δdt), which is the absolute value of the difference between the time (seconds) required for the average visible light transmittance to reach 15% from 60% at room temperature (dt₀) and the time (seconds) required for the average visible light transmittance to reach 15% from 60% after exposure to a temperature of 60° C. and a humidity of 60% for 7 days (dt₆₀), may be 9 seconds or less, 8 seconds or less, 7 seconds or less, 6 seconds or less, 5 seconds or less, 4 seconds or less, or 3 seconds or less.

When the difference in time (Δdt) of the electrochromic film measured after exposure to a temperature of 60° C. and a humidity of 60% for 7 days satisfies the above range, the chromic speed can be enhanced even in a harsh environment with high temperature and high humidity.

In Equation 3-1, dt₀ may be less than 170 seconds, 150 seconds or less, 143 seconds or less, or 140 seconds or less.

In Equation 3-1, dt₆₀ may be 180 seconds or less, 150 seconds or less, 148 seconds or less, 147 seconds or less, 145 seconds or less, 140 seconds or less, or 138 seconds or less.

In Equation 3-1, when dt₀ and dt₆₀ each satisfy the above range, the chromic speed is enhanced even in a harsh environment with high temperature and high humidity, which can be more advantageous for achieving the desired effect.

According to another embodiment, for a specimen of the electrochromic film having a width of 5 cm and a length of 5 cm, the heat shrinkage rate (S₈₀) represented by the following Equation 4 may be 2.5% or less:

$$Heat shrinkage rate ( {S}_{80} , \% ) = \frac{\vert {FT}_{0} - {FT}_{80} \vert}{{FT}_{0}} \times 100 \% \qquad [ Equation 4 ]$$

In Equation 4, FT₀ is the initial thickness (μm) of the electrochromic film at room temperature, and FT₈₀ is the thickness (μm) of the electrochromic film after exposure to 80° C. for 7 days.

The heat shrinkage rate (S₈₀) may be 2.0% or less, 1.8% or less, 1.5% or less, 1.0% or less, 0.9% or less, 0.8% or less, 0.7% or less, or 0.6% or less.

When the heat shrinkage rate (S₈₀) of the electrochromic film satisfies the above range, the heat shrinkage rate can be low even in a harsh environment with a high temperature of 80° C. or higher, whereby the performance of the electrochromic film can be maintained.

In Equation 4, FT₀ may be 300 μm to 400 μm, 320 μm to 400 μm, 320 μm to 380 μm, 330 μm to 360 μm, 340 μm to 360 μm, or 340 μm to 355 μm.

In Equation 4, FT₈₀ may be 300 μm to 400 μm, 320 μm to 400 μm, 320 μm to 380 μm, 330 μm to 360 μm, 340 μm to 360 μm, or 340 μm to 355 μm.

In Equation 4, when FT₀ and FT₈₀ each satisfy the above range, it can be more advantageous for achieving the desired effect even in a harsh environment with a high temperature of 80° C. or higher.

According to another embodiment, the electrochromic film having a width of 5 cm, a length of 5 cm, and a thickness of 500 μm is immersed in an organic solvent of methyl ethyl ketone (MEK) for 3 hours, and the electrochromic film and the methyl ethyl ketone (MEK) organic solvent are removed. Then, the amount of an unreacted residue remaining may be 40 mg or less. More specifically, it may be 30 mg or less, 20 mg or less, 10 mg or less, 5 mg or less, 3 mg or less, 2 mg or less, 1 mg or less, 0.5 mg or less, or almost none.

According to another embodiment, when it is exposed to 140° C. for 60 minutes, and the change in haze before and after exposure is observed with the naked eye, a smooth and transparent shape can be maintained.

In addition, the electrochromic film can maintain excellent chromic performance without thermal decomposition even in a harsh environment of 140° C. or higher.

### Effects and Uses of the Electrochromic Film

The electrochromic film can be applied to electrochromic devices, and it can be further applied as a smart window in various fields such as electronic devices, automobiles, and architecture.

The electrochromic film has a characteristic that the light transmittance is reversibly changed when electric power is applied. Thus, it is possible to selectively control the transmittance of sunlight and the like through a simple operation such as pressing a button, whereby the energy efficiency can be enhanced.

Specifically, when electric power is applied to the electrochromic film, an electric field is formed between the two electrodes, giving rise to coloration and decoloration, so that the transmittance can be adjusted for each wavelength of sunlight. Thus, an insulation function and a shading function can be advantageously achieved.

In particular, as the electrochromic film according to an embodiment comprises a repeat unit of a specific structure, it can exhibit a significantly faster rate of change in transmittance than those of conventional films. It has excellent thermal resistance and durability to maintain the skeletal structure of the electrolyte layer without thermal decomposition and to maintain smooth transport of lithium ions even in a harsh environment with above a specific temperature and/or above a specific humidity. It has little change in transmittance, and the chromic speed and performance can be further enhanced. In addition, the electrochromic film can be fabricated in an electrochromic device with a large area at a low cost, and its power consumption is low. Thus, it is suitable for use as a smart window, a smart mirror, or other next-generation architectural window materials.

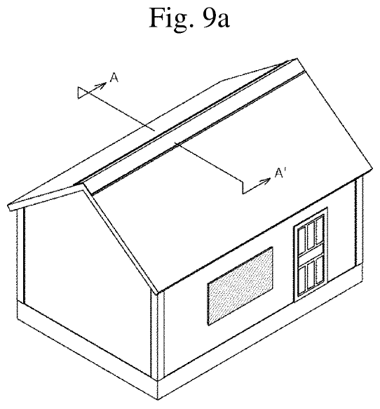

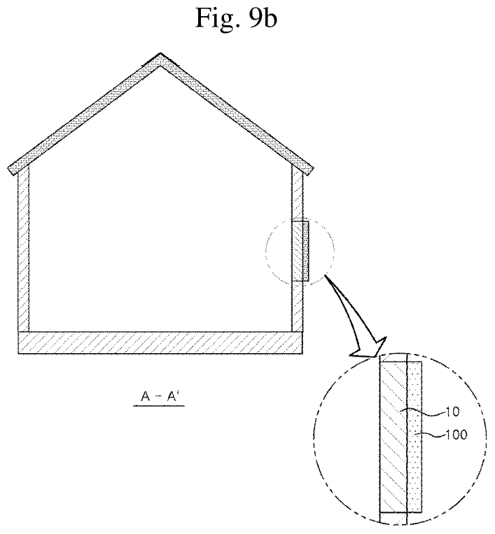

For example, an electrochromic device comprising the electrochromic film can be applied by simply attaching it to a structure such as a conventional transparent window. Specifically, as shown in FIG. 9a, it may be attached to one side of a window. More specifically, FIG. 9b shows a cross-sectional view taken along line A-A′ in FIG. 9a and an enlarged view of the part where the electrochromic film has been applied.

The electrochromic film (100) may be attached to one side of the window (10), wherein the window (10) may have a flat surface or a curved surface. In addition, the electrochromic film (100) may be attached to the entire side of the window (10) or may be attached to only a part of the window (10). In addition, the electrochromic film (100) may be inserted into the window (10). Specifically, the electrochromic film may be applied through a method of interposing it between glass substrates. More specifically, it can be applied in a way in which two polyvinyl butyral (PVB) films are interposed between laminated glasses of a window, and the electrochromic film is interposed between the two PVB films. It can be stably inserted into the window as it tightly attaches by applying heat.

### <Process for Preparing an Electrochromic Film>

In an embodiment, there is provided a process for preparing an electrochromic film, which comprises forming a base layer, a conductive layer on the base layer, a chromic layer on the conductive layer, and an electrolyte layer on the chromic layer, wherein the electrolyte layer is formed using an electrolyte composition comprising a polymer resin, a lithium salt compound, and a curing regulator, and the curing regulator comprises a repeat unit of the following Formula 1.

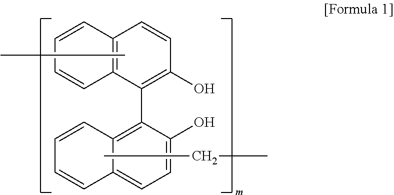

In Formula 1, m is 1 to 20.

The process for preparing an electrochromic film according to an embodiment can utilize various methods. As long as the electrolyte layer comprises a repeat unit of the specific structure and does not impair the desired effect, an electrochromic film can be prepared by various methods in various structures.

FIG. 6 schematically shows a process for preparing an electrochromic film according to an embodiment.

Referring to FIG. 6, a first conductive layer (131) may be formed on a first base layer (110) to prepare a lower plate, and a second conductive layer (139) may be formed on a second base layer (150) to prepare an upper plate. A first chromic layer (133) may be formed on the first conductive layer (131) of the lower plate, and a second chromic layer (137) may be formed on the second conductive layer (139) of the upper plate.

For example, the formation of the first conductive layer (131) and the second conductive layer (139) may be performed by vacuum sputtering, and the formation of the first chromic layer (133) and the second chromic layer (137) may be performed by wet coating. Thereafter, an electrolyte layer (135) may be formed on the first chromic layer (133) by wet coating, and the upper and lower plates are combined such that the electrolyte layer (135) comes in contact with the second chromic layer (137), thereby preparing an electrochromic film.

The electrolyte layer may be formed by coating a liquid or gel-like electrolyte composition on the first chromic layer or the second chromic layer. Specifically, the electrolyte layer (135) may be formed by coating an electrolyte composition to one side of any one of the first chromic layer (133) or the second chromic layer (137) by wet coating, sputtering coating, or both; and then drying it.

If the electrolyte layer is coated by a wet coating method, the thickness of the coating film can be increased or the thickness of the coating film can be easily controlled, which is advantageous from the viewpoint of enhancing ionic conductivity or chromic speed.

Meanwhile, an electrochromic device comprising the electrochromic film may be manufactured.

The electrochromic device may be manufactured by a conventional method. For example, a copper tape may be attached to the side of the conductive layer of the electrochromic film to form a bus bar that can be connected to a power source, whereby an electrochromic device is obtained.

### <Electrolyte Composition>

In an embodiment, there is provided an electrolyte composition, which comprises a polymer resin, a lithium salt compound, and a curing regulator, wherein the curing regulator comprises a repeat unit of the above Formula 1.

According to an embodiment, the electrolyte composition comprises a curing regulator having a repeat unit of the above Formula 1. Thus, when an electrochromic film and an electrochromic device are prepared using the electrolyte composition, they can exhibit a significantly faster rate of change in transmittance than those of conventional ones. It has excellent thermal resistance and durability to maintain the skeletal structure of the electrolyte layer without thermal decomposition and to maintain smooth transport of lithium ions even in a harsh environment with above a specific temperature and/or above a specific humidity. It has little change in transmittance, and the chromic speed and performance can be further enhanced.

Hereinafter, each component of the electrolyte composition will be described in detail.

### Polymer Resin

The electrolyte composition according to an embodiment may comprise a polymer resin.

The types of the polymer resin are as described above.

Specifically, the polymer resin may comprise an acrylic-based resin, an epoxy-based resin, a silicone-based resin, a polyimide-based resin, or a polyurethane-based resin. Specifically, the acrylic-based resin may be a thermosetting acrylic-based resin, a photocurable acrylic-based resin, or the like. The polyurethane-based resin may be a thermosetting polyurethane-based resin, a photocurable polyurethane-based resin, an aqueous polyurethane-based resin, or the like.

The acrylic-based resin may be a thermosetting acrylic-based resin or a photocurable acrylic-based resin. The acrylic-based resin upon polymerization may have a number average molecular weight of 100 to 1,000,000 g/mole. Specifically, the number average molecular weight of the acrylic-based resin may be 200 to 800,000 g/mole, 300 to 650,000 g/mole, or 500 to 400,000 g/mole, but it is not limited thereto. The acrylic-based resin may have a viscosity of 1,000 mPa·s to 10,000 mPa·s at room temperature, specifically, 3,000 mPa·s to 9,000 mPa·s. The acrylic-based resin may have a glass transition temperature (Tg) of −90° C. to −10° C., specifically, −70° C. to −30° C. The acrylic-based resin may have a visible light transmittance of 70% or more, 80% or more, or 90% or more.

In addition, it is preferable that the acrylic-based resin contains a carboxyl group in a side chain to impart adhesiveness and compatibility with additives.

The monomer unit constituting the acrylic-based resin may be, for example, 2-ethylhexyl acrylate, methyl (meth)acrylate, styrene, butyl acrylate, acrylamide, methyl acrylamide, hydroxyethyl (meth)acrylate, (meth)acrylic acid, itaconic acid, other monomers having an acrylate group of monofunctional, bifunctional, or higher, or a combination thereof.

The polymer resin may have a weight average molecular weight of 15,000 to 35,000 g/mole, 18,000 to 35,000 g/mole, 18,000 to 32,000 g/mole, or 20,000 to 30,000 g/mole. The weight average molecular weight (Mw) of the polymer resin may be measured by gel permeation chromatography (GPC).

The polymer resin may have a polydispersity (Mw/Mn) of 1.0 to 4.0, 1.5 to 3.5, 2.0 to 3.0, 2.5 to 3.5, or 2.5 to 3.0. The polydispersity may be measured by gel permeation chromatography (GPC).

### Lithium Salt Compound

The electrolyte composition according to an embodiment may comprise a lithium salt compound.

The types of the lithium salt compound are as described above.

The content of the lithium salt compound may be 5 parts by weight or more, 10 parts by weight or more, 15 parts by weight or more, or 20 parts by weight or more, and 50 parts by weight or less, 45 parts by weight or less, 40 parts by weight or less, or 30 parts by weight or less, relative to 100 parts by weight of the polymer resin. As a specific example, the content of the lithium salt compound may be 10 parts by weight to 50 parts by weight, 10 parts by weight to 40 parts by weight, or 10 parts by weight to 35 parts by weight, relative to 100 parts by weight of the polymer resin, for example, the acrylic-based resin.

The lithium salt compound may be used alone, or two or more types of lithium salt compounds may be used in combination.

When the lithium salt compound is used alone, for example, the lithium salt compound may be used in an amount of 10 parts by weight to 40 parts by weight relative to 100 parts by weight of the polymer resin.

When the lithium salt compound is used in combination, for example, LITFSI and LiPF₆ may be mixed in an amount of 9:1 to 1:9, and the lithium salt compound may be used in an amount of 10 parts by weight to 40 parts by weight relative to 100 parts by weight of the polymer resin.

The above content range may be based on the content of non-volatile components.

Since the lithium salt compound is generally in a solid crystalline form, a polar solvent may be added to the electrolyte to dissolve it. The polar solvent may be, for example, methyl ethyl ketone, propylene carbonate, dimethyl carbonate, ethyl methyl carbonate, ethyl propionate, methyl propionate, isopropyl alcohol, acetone, or the like. The polar solvent may be used in an amount of 40 parts by weight to 80 parts by weight, or 50 parts by weight to 70 parts by weight, relative to 100 parts by weight of the lithium salt compound.

### Curing Regulator

The electrolyte composition according to an embodiment may comprise a curing regulator.

The curing regulator may serve to prevent excessive curing by controlling the degree of curing of the polymer resin, and, at the same time, to maintain the skeletal structure of the electrolyte layer in the electrochromic film and to secure a passage for lithium ions.

The curing regulator according to an embodiment is an aromatic oligomer or polymer having a structure different from that of the polymer resin, and it is a compound containing binaphthol, for example, 1,1′-bi-2-naphthol, in the repeat unit.

The curing regulator can form a sufficient space between the structures where two naphthols are connected for the smooth transport of lithium ions, so that it can stably maintain the structure of the electrolyte layer, as well as secure a transport path for lithium ions. Further, thermal resistance and durability can be further enhanced. In particular, as the curing regulator comprises the above compound, the electrolyte layer can be strengthened, whereby excellent electrochromic performance can be maintained even after exposure to a harsh environment.

Specifically, the curing regulator according to an embodiment may comprise a repeat unit of the above Formula 1. The structural characteristics of the repeat unit of the above Formula 1 are as described above.

When the curing regulator comprises a repeat unit of the above specific structure, it may be advantageous for achieving the desired effect; in particular, it can enhance the durability, thermal resistance, and chromic speed of the electrochromic film.

In addition, the curing regulator may further comprise a repeat unit of the above Formula 2. The structural characteristics of the repeat unit of the above Formula 2 are as described above.

In addition, the curing regulator may comprise a repeat unit of the above Formula 3. The structural characteristics of the repeat unit of the above Formula 3 are as described above.

The curing regulator may have a weight average molecular weight of 1,500 to 6,000 g/mole, 2,000 to 5,000 g/mole, 2,500 to 4,500 g/mole, 2,500 to 4,000 g/mole, or 3,000 to 4,000 g/mole.

In addition, in a specific example, the weight average molecular weight of the curing regulator may be 1,500 to 6,000 g/mole, and the weight average molecular weight of the polymer resin may be 15,000 to 35,000 g/mole.

When the weight average molecular weight of the curing regulator satisfies the above range, the solubility and compatibility are excellent, and the thermal resistance and durability can be further enhanced.

If the weight average molecular weight of the curing regulator exceeds the above range, the solubility and compatibility may be deteriorated. If the molecular weight of the curing regulator is less than the above range, the thermal resistance and durability in an environment with high temperature and high humidity may not be sufficient.

The weight average molecular weight of the curing regulator may be 20% or less, 15% or less, or 10% or less, and may be 5% or more, or 8% or more, of the molecular weight of the polymer resin. The molecular weight of the curing regulator may be 5% to 20%, 5% to 18%, 8% to 18%, or 8% to 15%, of the molecular weight of the polymer resin.

In addition, when the curing regulator comprises a repeat unit of the above Formula 1 containing an aromatic structure, and the polymer resin comprises an aliphatic compound, the curing regulator and the polymer resin have different structures, resulting in excellent compatibility, whereby it is possible to provide a stable space to the backbone of the electrolyte layer, to help the smooth transport of lithium ions, and to enhance thermal resistance and durability.

For example, when the polymer resin comprises an aliphatic compound, the polymer resin may shrink when heated, which may narrow the space through which lithium ions can be transported. Therefore, especially when exposed to a harsh environment with high temperature and high humidity, this shrinkage phenomenon may hinder the transport of lithium ions to reduce the chromic speed. However, when the curing regulator containing a repeat unit of the above Formula 1 according to an embodiment is added, a sufficient space for lithium ions to be transported can be secured in the electrolyte layer, and thermal curing of the polymer resin can be prevented, thereby maintaining excellent electrochromic performance.

The curing regulator may have a polydispersity of 1.0 to 5.0, 1.0 to 4.0, 1.0 to 3.5, 1.5 to 3.0, or 2.0 to 3.0.

As a specific example, the curing regulator may have a molecular weight of 20% or less of the molecular weight of the polymer resin and a polydispersity of 1.0 to 5.0.

When the weight average molecular weight and/or polydispersity of the curing regulator satisfy the above range, it may be more advantageous for achieving the desired effect.

The weight average molecular weight and polydispersity may be measured by gel permeation chromatography (GPC).

The content of the curing regulator may be 1 to 20 parts by weight relative to 100 parts by weight of the polymer resin. Specifically, the content of the curing regulator may be 1 to 15 parts by weight, 1 to 12 parts by weight, 1 to 10 parts by weight, 1 to 8 parts by weight, 1 to 6 parts by weight, 1 to 5 parts by weight, 2 to 20 parts by weight, 2 to 15 parts by weight, 2 to 12 parts by weight, 2 to 10 parts by weight, 2 to 8 parts by weight, 2 to 6 parts by weight, 2 to 5 parts by weight, 3 to 20 parts by weight, 3 to 15 parts by weight, 3 to 12 parts by weight, 3 to 10 parts by weight, 3 to 8 parts by weight, 3 to 6 parts by weight, 3 to 5 parts by weight, 5 to 20 parts by weight, 5 to 15 parts by weight, 5 to 12 parts by weight, 5 to 10 parts by weight, 5 to 8 parts by weight, 8 to 20 parts by weight, 8 to 15 parts by weight, 8 to 12 parts by weight, 8 to 10 parts by weight, 10 to 20 parts by weight, 10 to 15 parts by weight, 10 to 12 parts by weight, 15 to 20 parts by weight, or 15 to 18 parts by weight, relative to 100 parts by weight of the polymer resin.

5 When the content of the curing regulator satisfies the above range, the thermal resistance of the electrolyte layer can be enhanced, and the durability in an environment with high temperature and high humidity can be excellent, whereby chromic performance such as chromic speed can be enhanced.

If the content of the curing regulator exceeds the above range, thermal decomposition or side reactions may take place under high-temperature conditions of 60° C. or higher or 80° C. or higher, and the curing regulator may not be firmly bonded to the polymer resin, whereby the effect may be reduced. In addition, if the content of the curing regulator is below the above range, the desired effect may be minimal.

According to an embodiment, a method for producing the curing regulator May comprise, for example, dissolving 1,1′-bi-2-naphthol, phenol, and 1,3,5-trioxane in a first solvent, and then adding p-toluenesulfonic acid monohydrate to obtain a curing regulator solution; and reacting the curing regulator solution.

The first solvent may comprise at least one selected from the group consisting of propylene glycol monomethyl ether acetate, ethyl acetate, n-butyl acetate, isobutyl acetate, ethylene glycol monomethyl ether acetate, ethylene glycol n-butyl ether acetate, diethylene glycol dimethyl ether, diethylene glycol monoethyl ether, dipropylene glycol monomethyl ether acetate, diethylene glycol methyl ethyl ether, diethylene glycol ethyl ether acetate, dipropylene glycol n-butyl ether, tripropylene glycol n-propyl ether, tripropylene glycol methyl ether, propylene glycol diacetate, propylene glycol monomethyl ether, propylene glycol monoethyl ether acetate, cyclohexanone, ethyl 3-methoxypropionate, methyl 3-ethoxypropionate, and ethyl 3-ethoxypropionate.

The above reaction may be a phenol-formaldehyde reaction. A curing regulator comprising a repeat unit of the above Formula 1, which comprises at least one repeat unit in which 1,1′-Bi-2-naphthol is connected to a methylene (CH₂) group, may be obtained through the above reaction.

The reaction is maintained, for example, at about 60° C. to 200° C., about 60° C. to 150° C., or about 80° C. to 120° C., for about 10 minutes to 5 hours, about 30 minutes to 4 hours, about 30 minutes to 3 hours, or about 30 minutes to 2 hours.

In addition, upon completion of the reaction, the product is slowly cooled to room temperature to terminate the reaction. The product is added dropwise to a solvent under stirring, and the obtained chemical reaction product is coagulated on the bottom surface of the flask, which is separated from the supernatant and dried to obtain the curing regulator.

The curing regulator may be prepared by various methods as long as it comprises the above repeat unit, and it is not limited to the above preparation method.

In addition, according to an embodiment, a curing regulator containing the repeat unit of the above Formula 1 may be prepared and used in an electrolyte composition.

According to another embodiment, a curing regulator containing the repeat unit of the above Formula 3 may be prepared and used in an electrolyte composition.

According to another embodiment, a first curing regulator containing the repeat unit of the above Formula 1 and a second curing regulator containing the repeat unit of the above Formula 2 are prepared, and the first curing regulator and the second curing regulator are compounded to prepare a mixed curing regulator, which may be used in an electrolyte composition.

Meanwhile, the method for preparing an electrolyte composition may comprise (1) dissolving a lithium salt compound in a second solvent to prepare a solution containing a lithium salt; (2) adding a polymer resin to the solution to prepare a resin mixture; and (3) adding a curing regulator to the resin mixture and mixing the mixture.

The second solvent may comprise at least one selected from the group consisting of ethanol, methyl ethyl ketone, propylene carbonate, dimethyl carbonate, ethyl methyl carbonate, ethyl propionate, methyl propionate, isopropyl alcohol, and acetone.

The specific types and amounts of the raw materials used in steps (1) to (3) are as exemplified above.

The mixing in step (2) may be performed at room temperature, for example, for 10 minutes to 1 hour while stirring at 300 rpm to 700 rpm until the mixture becomes transparent.

In addition, the mixing in step (3) may be performed at room temperature to 60° C., for example, for 30 minutes to 2 hours while stirring at 300 rpm to 700 rpm until the mixture becomes transparent.

### MODE FOR THE INVENTION

Hereinafter, the present invention will be described in more detail with reference to the following examples. However, these examples are set forth to illustrate the present embodiments, and the scope of the embodiments is not limited thereto.

### Preparation Example 1: Preparation of a Curing Regulator

### Preparation Example 1-1

Step 1-1: A 500-ml, 3-neck round flask equipped with a thermometer, a condenser (cooling reflux device), a dropping funnel, and a mechanical stirrer was prepared and immersed in a thermostat at about 100° C. The flask was charged with 43.0 g of 1,1′-bi-2-naphthol, 14.1 g of phenol, and 35.1 g of 1,3,5-trioxane, which were dissolved in about 150 g of propylene glycol monomethyl ether acetate. 2.85 g of p-toluenesulfonic acid monohydrate was added thereto.

Step 1-2: Upon completion of the addition in step 1-1, the temperature of the reactor was maintained at about 100° C. While the reaction was carried out, a sample was collected from the reaction mixture, and the weight average molecular weight (Mw) of the sample was measured. When the desired weight average molecular weight was reached, it was determined as the reaction completion point, and the reaction mixture was gradually cooled at room temperature to terminate the reaction.

Step 1-3: The product of step 1-2 was added dropwise to about 800 g of ethanol under stirring. The obtained chemical reaction product was coagulated on the bottom of the flask and separated from the supernatant. The resulting product was dried in a vacuum oven at about 80° C. to remove residual solvents and impurities, thereby obtaining a curing regulator. The obtained curing regulator was measured by gel permeation chromatography (GPC). The weight average molecular weight was about 3,200 g/mole, the polydispersity was about 1.9, and the molar ratio of the repeat unit of Formula 1 to the repeat unit of Formula 2 was 100:25.

### Preparation Example 1-2

A curing regulator was obtained by performing the same method as in Preparation

Example 1-1, except that the amounts of 1,1′-bi-2-naphthol, phenol, and 1,3,5-trioxane were changed such that the molar ratio of the repeat unit of Formula 1 to the repeat unit of Formula 2 to be contained in an electrolyte layer was 100:20.

### Preparation Example 1-3

A curing regulator was obtained by performing the same method as in Preparation Example 1-1, except that the amounts of phenol and 1,3,5-trioxane were changed, while 1,1′-bi-2-naphthol was not used, such that the molar ratio of the repeat unit of Formula 1 to the repeat unit of Formula 2 to be contained in an electrolyte layer was 0:100.

### Preparation Example 2: Preparation of a Polymer Resin

Step 2-1: A 1-liter, 3-neck round flask equipped with a thermometer, a condenser (cooling reflux device), a dropping funnel, and a mechanical stirrer was prepared and immersed in a thermostat at about 90° C. The flask was charged with about 300 g of ethyl acetate and about 1.5 g of azobisisobutyronitrile (AIBN) as a radical polymerization initiator, which were rotationally stirred at a speed of 100 revolutions per minute with the mechanical stirrer. Here, the temperature of the condenser was maintained at about 10° C.

Step 2-2: Another flask was charged with about 63 parts by weight (about 189 g) of butyl acrylate, about 9 parts by weight (about 27 g) of methyl methacrylate, about 17 parts by weight (about 51 g) of 2-hydroxyethyl acrylate, and about 10 parts by weight (about 30 g) of para-dodecyl styrene (C₂₀H₃₂), which were mixed for about 30 minutes with a mechanical stirrer. Thereafter, it was slowly added to the flask of step 2-1 using the dropping funnel.

Step 2-3: Upon completion of the addition, the temperature of the reactor was maintained at about 90° C. While the reaction was carried out, a sample was collected from the reaction mixture, and the weight average molecular weight (Mw) of the sample was measured. When the desired weight average molecular weight was reached, it was determined as the reaction completion point, and the reaction mixture was gradually cooled at room temperature to terminate the reaction. The compound (a liquid acrylic-based resin) thus obtained was measured by gel permeation chromatography (GPC). The weight average molecular weight was about 26,000 g/mole, and the polydispersity was about 2.7.

### Example 1

### Preparation of an Electrolyte Composition

About 10 parts by weight (about 100 g) of LITFSI (lithium bis(trifluoromethane) sulfonimide) and about 25 parts by weight (about 250 g) of LiPF₆ as lithium salt compounds were added to about 50 parts by weight (about 500 g) of propylene carbonate and about 15 parts by weight (about 150 g) of ethyl propionate, relative to 100 parts by weight of a polymer resin, and dissolved at about 40° C. to obtain a solution containing lithium salts.

About 40 g of the polymer resin obtained in Preparation Example 2 was added to 160 g of the above solution and mixed, and then 3 parts by weight of the curing regulator obtained in Preparation Example 1-1 was added to the mixture relative to 100 parts by weight of the polymer resin. The mixture was mixed at room temperature to obtain an electrolyte composition.

### Preparation of an Electrochromic Film

Two transparent electrode substrates in which a primer layer, a barrier layer, and an ITO electrode (with a surface resistance of 50 Ω/sq) as a conductive layer had been formed on a PET base layer (thickness: 125 μm) were prepared and used as upper and lower plates. In such an event, the sum of the thicknesses of the primer layer and the barrier layer was about 2 μm, and the conductive layer was about 100 nm in thickness.

A tungsten oxide (WO₃) paste was coated on the ITO conductive layer of the lower plate through wet coating and dried at 140° C. for 5 minutes to form a reducing chromic layer (thickness: 600 nm).

In addition, a Prussian blue-based pigment was coated on the ITO conductive layer of the upper plate through wet coating and dried at 140° C. for 5 minutes to form an oxidizing chromic layer (thickness: 400 nm).

The electrolyte composition was coated on the reducing chromic layer of the lower plate and dried at about 130° C. for 2 minutes to form an electrolyte layer (dry thickness of about 100 μm) having a molar ratio of the repeat unit of Formula 1 and the repeat unit of Formula 2 shown in Table 1 below.

The lower and upper plates were combined such that oxidizing chromic layer was on the electrolyte layer, which was placed in an oven and cured at 130° C. for 2 minutes to obtain an electrochromic film having a width of 300 mm, a length of 500 mm, and a thickness of 500 μm.

### Preparation of an Electrochromic Device

A copper tape was attached to the side of the ITO conductive layers of the upper and lower plates of the electrochromic film to form a bus bar that can be connected to a power source, whereby an electrochromic device was obtained.

The edges of the electrochromic device were sealed with a silicone sealant.

### Example 2

An electrochromic film and an electrochromic device were obtained by performing the same method as Example 1, except that an electrolyte composition obtained by adding 5 parts by weight of the curing regulator obtained in Preparation Example 1-1 relative to 100 parts by weight of the polymer resin was used as shown in Table 1 below.

### Example 3

An electrochromic film and an electrochromic device were obtained by performing the same method as Example 1, except that an electrolyte composition obtained by adding 10 parts by weight of the curing regulator obtained in Preparation Example 1-2 relative to 100 parts by weight of the polymer resin was used as shown in Table 1 below.

### Example 4

An electrochromic film and an electrochromic device were obtained by performing the same method as Example 1, except that an electrolyte composition obtained by adding 15 parts by weight of the curing regulator obtained in Preparation Example 1-2 relative to 100 parts by weight of the polymer resin was used as shown in Table 1 below.

### Example 5

An electrochromic film and an electrochromic device were obtained by performing the same method as Example 1, except that an electrolyte composition obtained by adding 20 parts by weight of the curing regulator obtained in Preparation Example 1-1 relative to 100 parts by weight of the polymer resin was used as shown in Table 1 below.

### Comparative Example 1

The lower and upper plates were combined such that the oxidizing chromic layer was on the reducing chromic layer of the lower plate as shown in Table 1 below, which was placed in an oven and cured at 130° C. for 2 minutes to obtain an electrochromic film having a width of 300 mm, a length of 500 mm, and a thickness of 400 μm.

### Comparative Example 2

An electrochromic film and an electrochromic device were obtained by performing the same method as Example 1, except that an electrolyte composition obtained by adding 5 parts by weight of the curing regulator obtained in Preparation Example 1-3 relative to 100 parts by weight of the polymer resin was used as shown in Table 1 below.

### EVALUATION EXAMPLE

### Evaluation Example 1: Transmittance Characteristics of Electrochromic Films

The following tests were carried out on the electrochromic films prepared in the Examples and Comparative Examples.

### A. Measuring Device

Fluke 175 True RMS multimeter from Fluke was used for electrical measurements.
DP-30 from Toyotech was used for the power supply.
SD 2400 from EDTM, USA, was used for transmittance measurements.

### B. Specimen:

Electrochromic films of Examples 1 to 5 and Comparative Examples 1 and 2, in the dimensions of a width of 300 mm, a length of 500 mm, and a thickness of 500 μm

C. Test method
(1) Initialization: A voltage of 2.4 V was applied to each specimen at room temperature to achieve maximum decoloration.
(2) Coloration test: A voltage of −1.2 V was applied to the specimen in the maximally decolored state such that it changed to the maximally colored state. The transmittance was measured over time.
(3) Decoloration test: A voltage of 1.2 V was applied to the specimen in the maximally colored state such that it changed to the maximally decolored state. The transmittance was measured over time.
(4) The tests were carried out by repeating the procedures (2) and (3) as needed.

### D. Transmittance Measurement

Referring to FIGS. 7 and 8, a specimen of the electrochromic film (100) was placed between a light source (210) and a measuring device (220), the visible light transmittance at a wavelength ranging from about 30 nm to 60 nm was measured at the center point (P1) and four edge points (P2, P3, P4, and P5), excluding 30 mm from each end of the specimen of the electrochromic film (100), and the average visible light transmittance value of P1 to P5 was obtained.

Meanwhile, various transmittance characteristics of the electrochromic film specimens were evaluated using the above method.

### Difference in Transmittance in the Maximally Colored State (ΔT60_{dis})

For a specimen of each electrochromic film having a width of 300 mm, a length of 500 mm, and a thickness of 500 μm, the average visible light transmittance in the maximally colored state was measured, and the difference in transmittance (ΔT60_{dis}) in the maximally colored state represented by the following Equation 1-1 was calculated.

$$Δ T {60}_{dis} ( \% ) = \vert {T}_{dis 0} - {T}_{dis 60} \vert \qquad [ Equation 1 - 1 ]$$

In Equation 1-1, T_{dis0} is the initial transmittance (%) of the specimen in the maximally colored state measured at room temperature, and T_{dis60} is the transmittance (%) of the specimen in the maximally colored state measured after exposure to a temperature of 60° C. and a humidity of 60% for 7 days.

The results are shown in Table 2 below.

### Difference in Transmittance in the Maximally Decolored State (ΔT60_{de})

For a specimen of each electrochromic film having a width of 300 mm, a length of 500 mm, and a thickness of 500 μm, the average visible light transmittance in the maximally decolored state was measured, and the difference in transmittance (ΔT60_{de}) in the maximally decolored state represented by the following Equation 1-2 was calculated.

$$Δ T {60}_{de} ( \% ) = \vert {T}_{de 0} - {T}_{de 60} \vert \qquad [ Equation 1 - 2 ]$$

In Equation 1-2, T_{de0} is the initial transmittance (%) of the specimen in the maximally decolored state measured at room temperature, and T_{de60} is the transmittance (%) of the specimen in the maximally decolored state measured after exposure to a temperature of 60° C. and a humidity of 60% for 7 days.

The results are shown in Table 2 below.

### Difference in Transmittance in the Maximally Colored State (ΔT80_{dis})

In addition, for a specimen of each electrochromic film having a width of 300 mm, a length of 500 mm, and a thickness of 500 μm, the average visible light transmittance in the maximally colored state was measured, and the difference in transmittance (ΔT80_{dis}) in the maximally colored state represented by the following Equation 2-1 was calculated.

$$Δ T {80}_{dis} ( \% ) = \vert {T}_{dis 0} - {T}_{dis 80} \vert \qquad [ Equation 2 - 1 ]$$

In Equation 2-1, T_{dis0} is the initial transmittance (%) of the specimen in the maximally colored state measured at room temperature, and T_{dis80} is the transmittance (%) of the specimen in the maximally colored state measured after exposure to a temperature of 80° C. for 7 days.

The results are shown in Table 3 below.

### Difference in Transmittance in the Maximally Decolored State (ΔT80_{de})

For a specimen of each electrochromic film having a width of 300 mm, a length of 500 mm, and a thickness of 500 μm, the average visible light transmittance in the maximally decolored state was measured, and the difference in transmittance (ΔT80_{de}) in the maximally decolored state represented by the following Equation 2-2 was calculated.

$$Δ T {80}_{de} ( \% ) = \vert {T}_{de 0} - {T}_{de 80} \vert \qquad [ Equation 2 - 2 ]$$

In Equation 2-2, I_{de0} is the initial transmittance (%) of the specimen in the maximally decolored state measured at room temperature, and T_{de80} is the transmittance (%) of the specimen in the maximally decolored state measured after exposure to a temperature of 80° C. for 7 days.

The results are shown in Table 3 below.

### Change Rate of Chromic Speed (Dt)

For a specimen of each electrochromic film having a width of 300 mm, a length of 500 mm, and a thickness of 500 μm, the change rate of chromic speed (Dt) represented by the following Equation 3 was calculated.

$$Change rate of chromic speed ( Dt , \% ) = \frac{\vert {dt}_{0} \vert - \vert {dt}_{60} \vert}{{dt}_{0}} \times 100 \% \qquad [ Equation 3 ]$$

In Equation 3, dt₀ is the time (seconds) required for the average visible light transmittance to reach 15% from 60% at room temperature, and dT₆₀ is the time (seconds) required for the average visible light transmittance to reach 15% from 60% after exposure to a temperature of 60° C. and a humidity of 60% for 7 days.

The results are shown in Table 4 below.

### Difference in Time (ΔDt)

The difference in time (Δdt) represented by the following Equation 3-1 was calculated using the dt₀ and dt₆₀ values.

$$Δ dt ( seconds ) = \vert {dt}_{0} - {dt}_{60} \vert \qquad [ Equation 3 - 1 ]$$

In Equation 3-1, dt₀ and dt₆₀ are each as described above.

The results are shown in Table 4 below.

However, if the samples are not identical, differences in initial transmittance may occur due to preparation and measurement variables of each sample.

### Evaluation Example 2: Heat Shrinkage Rate (S₈₀) of Electrochromic Films

for a specimen of the electrochromic film having a width of 5 cm and a length of 5 cm, the initial thickness (μm) of the electrochromic film at room temperature and the thickness (μm) of the electrochromic film after exposure to 80° C. for 7 days were measured to evaluate the heat shrinkage rate (S₈₀) represented by the following Equation 4:

$$Heat shrinkage rate ( {S}_{80} , \% ) = \frac{\vert {FT}_{0} - {FT}_{80} \vert}{{FT}_{0}} \times 100 \% \qquad [ Equation 4 ]$$

In Equation 4, FT₀ is the initial thickness (μm) of the electrochromic film at room temperature, and FT₈₀ is the thickness (μm) of the electrochromic film after exposure to 80° C. for 7 days.

The results are shown in Table 5 below.

### Evaluation Example 3: Change in Shape of Electrochromic Films when Exposed to a Harsh Environment with High Temperature and High Humidity

The electrochromic films obtained in the Examples and Comparative Examples in a size of 5 cm in width, 5 cm in length, and 400 μm in thickness were each exposed to 140° C. for 60 minutes, and the shape changes of the electrochromic films before and after exposure were observed with the naked eye. The results are shown in Table 6 below.

### Evaluation Example 4: Amount of Residue

The electrochromic films obtained in the Examples and Comparative Examples were each cut into pieces of 5 cm in width and 5 cm in length, immersed in an organic solvent of methyl ethyl ketone (MEK) for 3 hours, and then shaken for 3 hours. The solution was moved to a flask, and it was completely evaporated using a vacuum evaporator to remove the electrochromic film and the methyl ethyl ketone (MEK) organic solvent. The amount of an unreacted residue remaining was measured. The results are shown in Table 6 below.

TABLE 1

| | | Ex. 1 | Ex. 2 | Ex. 3 | Ex. 4 | Ex. 5 | C. Ex. 1 | C. Ex. 2 |
|---|---|---|---|---|---|---|---|---|
| Curing | Main component | 1,1′-bi-2-naphthol | | | | | — | phenol |
| regulator | Content¹⁾ | 3 | 5 | 10 | 15 | 20 | 0 | 5 |
| | (part by weight) | | | | | | | |
| | Mw (g/mole) | 3,200 | 3,200 | 3,200 | 3,200 | 3,200 | — | 2,000 |
| | Polydispersity | 1.9 | 1.9 | 1.9 | 1.9 | 1.9 | — | 1.8 |
| Electrolyte | Molar ration of repeat | 100:25 | 100:25 | 100:20 | 100:20 | 100:25 | — | 100:0 |
| layer | unit of Formula 1²⁾: | | | | | | | |
| | repeat unit of | | | | | | | |
| | Formula 2³⁾ | | | | | | | |

¹⁾Relative to 100 parts by weight of the polymer resin;
²⁾³⁾Formulae 1 and 2 are as defined above.

TABLE 2

| | Ex. 1 | | Ex. 2 | | Ex. 3 | | Ex. 4 | |
|---|---|---|---|---|---|---|---|---|
| Operation | Col'n | Decol'n | Col'n | Decol'n | Col'n | Decol'n | Col'n | Decol'n |
| Initial transmittance | T_{dis0} | T_{de0} | T_{dis0} | T_{de0} | T_{dis0} | T_{de0} | T_{dis0} | T_{de0} |
| (%) | 66.5 | 13.2 | 66.2 | 13.3 | 66.3 | 13.1 | 65.9 | 13.4 |
| Transmittance (%) | T_{dis60} | T_{de60} | T_{dis60} | T_{de60} | T_{dis60} | T_{de60} | T_{dis60} | T_{de60} |
| after exposure to | | | | | | | | |
| 60° C./60%, 7 days | 65.6 | 13.4 | 66.0 | 12.9 | 65.5 | 13.5 | 65.5 | 13.7 |
| Transmittance | ΔT60_{dis} | ΔT60_{de} | ΔT60_{dis} | ΔT60_{de} | ΔT60_{dis} | ΔT60_{de} | ΔT60_{dis} | ΔT60_{de} |
| difference (%) | 0.9 | 0.2 | 0.2 | 0.4 | 0.8 | 0.4 | 0.4 | 0.3 |

| | Ex. 5 | | C. Ex. 1 | | C. Ex. 2 | |
|---|---|---|---|---|---|---|
| Operation | Col'n | Decol'n | Col'n | Decol'n | Col'n | Decol'n |
| Initial transmittance | T_{dis0} | T_{de0} | T_{dis0} | T_{de0} | T_{dis0} | T_{de0} |
| (%) | 59.5 | 14.9 | 65.5 | 13.2 | 65.7 | 13.4 |
| Transmittance (%) | T_{dis60} | T_{de60} | T_{dis60} | T_{de60} | T_{dis60} | T_{de6}0 |
| after exposure to | | | | | | |
| 60° C./60%, 7 days | 58.0 | 15.5 | 62.0 | 14.5 | 61.8 | 14.6 |
| Transmittance | ΔT60_{dis} | ΔT60_{de} | ΔT60_{dis} | ΔT60_{de} | ΔT60_{dis} | ΔT60_{de} |
| difference (%) | 1.5 | 0.6 | 3.5 | 1.3 | 3.9 | 1.2 |

TABLE 3

| | Ex. 1 | | Ex. 2 | | Ex. 3 | | Ex. 4 | |
|---|---|---|---|---|---|---|---|---|
| Operation | Col'n | Decol'n | Col'n | Decol'n | Col'n | Decol'n | Col'n | Decol'n |
| Initial transmittance | T_{dis0} | T_{de0} | T_{dis0} | T_{de0} | T_{dis0} | T_{de0} | T_{dis0} | T_{de0} |
| (%) | 66.1 | 13.3 | 66.0 | 13.5 | 65.8 | 13.3 | 65.5 | 13.8 |
| Transmittance (%) | T_{dis80} | T_{de80} | T_{dis80} | T_{de80} | T_{dis80} | T_{de80} | T_{dis80} | T_{de80} |
| after exposure to | | | | | | | | |
| 80° C., 7 days | 64.7 | 14.4 | 65.0 | 14.0 | 65.0 | 13.9 | 65.0 | 14.2 |
| Transmittance | ΔT80_{dis} | ΔT80_{de} | ΔT80_{dis} | ΔT80_{de} | ΔT80_{dis} | ΔT80_{de} | ΔT80_{dis} | ΔT80_{de} |
| difference (%) | 1.4 | 1.1 | 1.0 | 0.5 | 0.8 | 0.6 | 0.5 | 0.4 |

| | Ex. 5 | | C. Ex. 1 | | C. Ex. 2 | |
|---|---|---|---|---|---|---|
| Operation | Col'n | Decol'n | Col'n | Decol'n | Col'n | Decol'n |
| Initial transmittance | T_{dis0} | T_{de0} | T_{dis0} | T_{de0} | T_{dis0} | T_{de0} |
| (%) | 59.2 | 15.0 | 65.4 | 13.1 | 65.6 | 13.4 |
| Transmittance (%) | T_{dis80} | T_{de80} | T_{dis80} | T_{de80} | T_{dis80} | T_{de80} |
| after exposure to | | | | | | |
| 80° C., 7 days | 57.5 | 16.6 | 59.0 | 15.2 | 60.5 | 14.9 |
| Transmittance | ΔT80_{dis} | ΔT80_{de} | ΔT80_{dis} | ΔT80_{de} | ΔT80_{dis} | ΔT80_{de} |
| difference (%) | 1.7 | 1.6 | 6.4 | 2.1 | 5.1 | 1.5 |

As can be seen from Tables 2 and 3 above, the electrochromic films of Examples 1 to 5, in which the electrolyte layer comprised a repeat unit of Formula 1, had a strong backbone structure of the electrolyte layer, so that even when exposed to a harsh environment of a temperature of 60° C., a humidity of 60%, or 80° C., for 7 days or more, the difference in transmittance between the maximally colored and decolored states was low, and the transmittance was maintained at a certain level or higher even in the harsh environment, when compared with the electrochromic films of Comparative Example 1, in which an electrolyte layer was not adopted, and Comparative Example 2, in which an electrolyte layer containing only a repeat unit of Formula 2 was adopted.

Meanwhile, although the electrochromic film of Comparative Example 2, in which an electrolyte layer containing only a repeat unit of Formula 2 was adopted, was slightly improved from the electrochromic film of Comparative Example 1, in which an electrolyte layer was not adopted, the transmittance performance was lower than that of the electrochromic films of Examples 1 to 5.

It is understood that in the electrochromic film of Comparative Example 2, in which an electrolyte layer containing only a repeat unit of Formula 2 was adopted, there was a limit to securing the formation of a space that facilitates the transport of lithium ions within the electrolyte layer because it lacked the bulky repeat unit of Formula 1, and the thermal resistance was not sufficient, so that the transmittance performance was deteriorated in light of the content of the curing regulator.

TABLE 4

| | Ex. 1 | Ex. 2 | Ex. 3 | Ex. 4 | Ex. 5 | C. Ex. 1 | C. Ex. 2 |
|---|---|---|---|---|---|---|---|
| Time required for the | 143 | 140 | 135 | 133 | 137 | 170 | 168 |
| transmittance at room | | | | | | | |
| temperature to reach 15% from | | | | | | | |
| 60% (dto, seconds) | | | | | | | |
| Time required for the | 147 | 138 | 134 | 133 | 139 | 181 | 175 |
| transmittance to reach 15% | | | | | | | |
| from 60% after exposure to | | | | | | | |
| 60° C./60% for 7 days (dt₆₀, | | | | | | | |
| seconds) | | | | | | | |
| Δdt (seconds) | 4 | 2 | 1 | 0 | 2 | 11 | 7 |
| Change rate of chromic speed | 2.8 | 1.4 | 0.7 | — | 1.5 | 6.5 | 4.2 |
| (Dt, %) | | | | | | | |

As can be seen from Table 4 above, in the electrochromic films of Examples 1 to 5, in which the electrolyte layer comprised a repeat unit of Formula 1, the chromic speed of the transmittance to reach 15% from 60% at a temperature of 60° C. and a humidity of 60% was enhanced, and the change rate of chromic speed was reduced even when exposed to the harsh environment for 7 days, as compared with the electrochromic films of Comparative Example 1, in which an electrolyte layer was not adopted, and Comparative Example 2, in which an electrolyte layer containing only a repeat unit of Formula 2 was adopted.

TABLE 5

| | Ex. 1 | Ex. 2 | Ex. 3 | Ex. 4 | Ex. 5 | C. Ex. 1 | C. Ex. 2 |
|---|---|---|---|---|---|---|---|
| Initial thickness at room | 350 | 352 | 349 | 345 | 348 | 352 | 350 |
| temperature before | | | | | | | |
| exposure (FT₀, μm) | | | | | | | |
| Thickness after exposure to | 347 | 350 | 348 | 344 | 346 | 343 | 343 |
| 80° C. for 7 days (FT₈₀, μm) | | | | | | | |
| ΔFT | 3 | 2 | 1 | 2 | 2 | 9 | 7 |
| Heat shrinkage rate (S₈₀, %) | 0.9 | 0.6 | 0.3 | 0.6 | 0.6 | 2.6 | 2.0 |

As can be seen from Table 5 above, in the electrochromic films of Examples 1 to 5, in which the electrolyte layer comprised a repeat unit of Formula 1, the heat shrinkage rate even after exposure to a harsh environment at 80° C. for 7 days was significantly reduced, as compared with the electrochromic films of Comparative Example 1, in which an electrolyte layer was not adopted, and Comparative Example 2, in which an electrolyte layer containing only a repeat unit of Formula 2 was adopted.

TABLE 6

| | Ex. 1 | Ex. 2 | Ex. 3 | Ex. 4 | Ex. 5 | C. Ex. 1 | C. Ex. 2 |
|---|---|---|---|---|---|---|---|
| Visual | Smooth | Smooth | Smooth | Smooth | Smooth | Smooth | Smooth |
| observation | and | and | and | and | with slight | and | and |
| (Before | transparent | transparent | transparent | transparent | red color | transparent | transparent |
| exposure) | shape | shape | shape | shape | observed | shape | shape |
| Visual | Slight haze | Smooth | Smooth | Smooth | Slight haze | Haze | Slight haze |
| observation | | and | and | and | of red color | observed | |
| (after exposure | | transparent | transparent | transparent | | | |
| to 140° C. for 60 | | shape | shape | shape | | | |
| minutes) | | | | | | | |
| Amount of | 17 | None | None | None | 11 | 47 | 40 |
| residue | | | | | | | |
| (weight change | | | | | | | |
| of flask, mg) | | | | | | | |

As can be seen from Table 6 above, in the electrochromic films of Examples 1 to 5, in which the electrolyte layer comprised a repeat unit of Formula 1, there was little thermal decomposition, and the shape was maintained smooth and transparent even after exposure to a harsh environment at a temperature of 140° C. for 60 minutes, while the amount of residue was 17 mg or less, and the amount of residue was almost zero in most cases, as compared with the electrochromic films of Comparative Example 1, in which an electrolyte layer was not adopted, and Comparative Example 2, in which an electrolyte layer containing only a repeat unit of Formula 2 was adopted.

1. An electrochromic film, which comprises a base layer, a conductive layer, a chromic layer, and an electrolyte layer, wherein the electrolyte layer comprises a repeat unit of the following Formula 1: 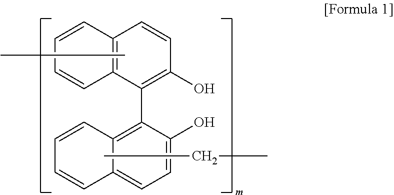
in Formula 1, m is 1 to 20.

2. The electrochromic film of claim 1, wherein the electrolyte layer comprises a repeat unit of the following Formula 2: 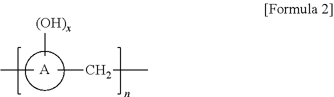
in Formula 2, A is an aromatic group, n is 1 to 30, and x is 1 or 2.

3. The electrochromic film of claim 2, wherein the electrolyte layer comprises the repeat unit of the above Formula 1 and the repeat unit of the above Formula 2 at a molar ratio of 100:0 to 100:50.

4. The electrochromic film of claim 1, wherein for a specimen of the electrochromic film having a width of 300 mm, a length of 500 mm, and a thickness of 500 μm,
when the average visible light transmittance is measured in the maximally colored state, the difference in transmittance (ΔT60_{dis}) in the maximally colored state represented by the following Equation 1-1 is less than 3.5%, and
when the average visible light transmittance is measured in the maximally decolored state, the difference in transmittance (ΔT60_{de}) in the maximally decolored state represented by the following Equation 1-2 is 1.2% or less:
$$Δ T {60}_{dis} ( \% ) = \vert {T}_{dis 0} - {T}_{dis 60} \vert \qquad [ Equation 1 - 1 ]$$
in Equation 1-1, T_{dis0} is the initial transmittance (%) of the specimen in the maximally colored state measured at room temperature, and T_{dis60} is the transmittance (%) of the specimen in the maximally colored state measured after exposure to a temperature of 60° C. and a humidity of 60% for 7 days,
$$Δ T {60}_{de} ( \% ) = \vert {T}_{de 0} - {T}_{de 60} \vert \qquad [ Equation 1 - 2 ]$$
in Equation 1-2, T_{de0} is the initial transmittance (%) of the specimen in the maximally decolored state measured at room temperature, and T_{de60} is the transmittance (%) of the specimen in the maximally decolored state measured after exposure to a temperature of 60° C. and a humidity of 60% for 7 days.

5. The electrochromic film of claim 1, wherein for a specimen of the electrochromic film having a width of 300 mm, a length of 500 mm, and a thickness of 500 μm,
when the average visible light transmittance is measured in the maximally colored state, the difference in transmittance (ΔT80_{dis}) in the maximally colored state represented by the following Equation 2-1 is 6.0% or less, and
when the average visible light transmittance is measured in the maximally decolored state, the difference in transmittance (ΔT80_{de}) in the maximally decolored state represented by the following Equation 2-2 is 2.0% or less:
$$Δ T {80}_{dis} ( \% ) = \vert {T}_{dis 0} - {T}_{dis 80} \vert \qquad [ Equation 2 - 1 ]$$
in Equation 2-1, T_{dis0} is the initial transmittance (%) of the specimen in the maximally colored state measured at room temperature, and T_{dis80} is the transmittance (%) of the specimen in the maximally colored state measured after exposure to a temperature of 80° C. for 7 days,
$$Δ T {80}_{de} ( \% ) = \vert {T}_{de 0} - {T}_{de 80} \vert \qquad [ Equation 2 - 2 ]$$
in Equation 2-2, T_{de0} is the initial transmittance (%) of the specimen in the maximally decolored state measured at room temperature, and T_{de80} is the transmittance (%) of the specimen in the maximally decolored state measured after exposure to a temperature of 80° C. for 7 days.

6. The electrochromic film of claim 1, wherein for a specimen of the electrochromic film having a width of 300 mm, a length of 500 mm, and a thickness of 500 μm,
the change rate of chromic speed (Dt) represented by the following Equation 3 is 6.0% or less:
$$Change rate of chromic speed ( Dt , \% ) = \frac{\vert {dt}_{0} \vert - \vert {dt}_{60} \vert}{{dt}_{0}} \times 100 \% \qquad [ Equation 3 ]$$
in Equation 3, dt₀ is the time (seconds) required for the average visible light transmittance to reach 15% from 60% at room temperature, and dT₆₀ is the time (seconds) required for the average visible light transmittance to reach 15% from 60% after exposure to a temperature of 60° C. and a humidity of 60% for 7 days.

7. The electrochromic film of claim 6, wherein the difference in time (Δdt) represented by the following Equation 3-1 is 10 seconds or less:
$$Δ dt ( seconds ) = \vert {dt}_{0} - {dt}_{60} \vert \qquad [ Equation 3 - 1 ]$$
in Equation 3-1, dt₀ and dt₆₀ are each as defined in claim 6.

8. The electrochromic film of claim 1, wherein for a specimen of the electrochromic film having a width of 5 cm and a length of 5 cm, the heat shrinkage rate (S₈₀) represented by the following Equation 4 is 2.5% or less:
$$Heat shrinkage rate ( {S}_{80} , \% ) = \frac{\vert {FT}_{0} - {FT}_{80} \vert}{{FT}_{0}} \times 100 \% \qquad [ Equation 4 ]$$
in Equation 4, FT₀ is the initial thickness (μm) of the electrochromic film at room temperature, and FT₈₀ is the thickness (μm) of the electrochromic film after exposure to 80° C. for 7 days.

9. The electrochromic film of claim 1, wherein when the electrochromic film having a width of 5 cm, a length of 5 cm, and a thickness of 500 μm is immersed in an organic solvent of methyl ethyl ketone (MEK) for 3 hours, and the electrochromic film and the methyl ethyl ketone (MEK) organic solvent are removed, the amount of an unreacted residue remaining is 40 mg or less.

10. A process for preparing an electrochromic film, which comprises forming a base layer, a conductive layer on the base layer, a chromic layer on the conductive layer, and an electrolyte layer on the chromic layer,
wherein the electrolyte layer is formed using an electrolyte composition comprising a polymer resin, a lithium salt compound, and a curing regulator, and the curing regulator comprises a repeat unit of the following Formula 1: 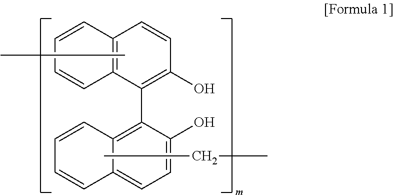
in Formula 1, m is 1 to 20.

11. An electrolyte composition, which comprises a polymer resin, a lithium salt compound, and a curing regulator, wherein the curing regulator comprises a repeat unit of the following Formula 1: 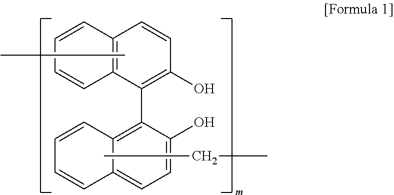
in Formula 1, m is 1 to 20.

12. The electrolyte composition of claim 11, wherein the content of the curing regulator is 1 to 20 parts by weight relative to 100 parts by weight of the polymer resin.

13. The electrolyte composition of claim 11, wherein the curing regulator has a molecular weight of 20% or less of the molecular weight of the polymer resin and a polydispersity of 1.0 to 5.0.

14. The electrolyte composition of claim 11, wherein the weight average molecular weight of the curing regulator is 1,500 to 6,000 g/mole, and the weight average molecular weight of the polymer resin is 15,000 to 35,000 g/mole.
